(19) United States
(12) Patent Application Publication
(10) Pub. No.: US 2025/0141621 A1
(43) Pub. Date: May 1, 2025

(54) WIRELESS COMMUNICATION METHOD FOR POSITIONING, DEVICE, AND CHIP

(71) Applicant: GUANGDONG OPPO MOBILE TELECOMMUNICATIONS CORP., LTD., Dongguan (CN)

(72) Inventor: Zuomin WU, Dongguan (CN)

(21) Appl. No.: 19/006,476

(22) Filed: Dec. 31, 2024

Related U.S. Application Data
(63) Continuation of application No. PCT/CN2022/111935, filed on Aug. 11, 2022.

(51) Int. Cl. H04L 5/00; H04W 64/00; H04W 72/0446

(52) U.S. Cl. CPC H04L 5/005; H04W 64/00; H04W 72/0446

(57) ABSTRACT

A wireless communication method for positioning, applicable to a terminal device, is provided. The method includes: receiving first configuration information, wherein the first configuration information is used for determining M downlink positioning signal resources and/or N uplink positioning signal resources, wherein M and N are positive integers; and reporting first measurement information based on the first configuration information, wherein the first measurement information includes at least one of a first time difference or first time information.

### CROSS-REFERENCE TO RELATED APPLICATION

This application is a continuation application of international application No. PCT/CN2022/111935, filed on Aug. 11, 2022, the entire content of which is incorporated herein by reference.

### TECHNICAL FIELD

The present disclosure relates to the field of positioning, and in particular, relates to a wireless communication method for positioning, and a device and a chip.

### RELATED ART

The 5^{th} generation mobile communication technology (5G) new radio (NR) introduces a variety of positioning techniques for positioning terminal devices.

### SUMMARY

Embodiments of the present disclosure provide a wireless communication method for positioning, and a device and a chip. The technical solutions are as follows.

According to some embodiments of the present disclosure, a wireless communication method for positioning is provided. The method is applicable to a terminal device, and includes:
receiving first configuration information, wherein the first configuration information is used for determining M downlink positioning signal resources, and/or N uplink positioning signal resources, wherein M and N are positive integers; and
reporting first measurement information based on the first configuration information, wherein the first measurement information includes at least one of a first time difference and first time information.

According to some embodiments of the present disclosure, a wireless communication method for positioning is provided. The method is applicable to a network device or a serving satellite device, and the method includes:
acquiring first configuration information, wherein the first configuration information is used for determining M downlink positioning signal resources, and/or N uplink positioning signal resources, wherein M and N are positive integers; and
determining or reporting second measurement information based on the first configuration information, wherein the second measurement information includes at least one of a second time difference or second time information.

According to some embodiments of the present disclosure, a terminal device is provided. The terminal device includes: a processor; a transceiver coupled to the processor; and a memory configured to store one or more executable instructions; wherein the processor, when loading and executing the one or more executable instructions, is caused to perform the wireless communication method for positioning as described in the above embodiments.

According to some embodiments of the present disclosure, a network device is provided. The network device includes: a processor; a transceiver coupled to the processor; and a memory configured to store one or more executable instructions; wherein the processor, when loading and executing the one or more executable instructions, is caused to perform the wireless communication method for positioning as described in the above embodiments.

According to some embodiments of the present disclosure, a chip is provided. The chip includes at least one programmable logic circuit and/or at least one program instruction, wherein the chip, when running on a communication device, is caused to perform the wireless communication method for positioning as described in the above embodiments

### BRIEF DESCRIPTION OF DRAWINGS

For clearer descriptions of the technical solutions according to the embodiments of the present disclosure, the following briefly describes accompanying drawings required for describing the embodiments. Apparently, the accompanying drawings in the following description illustrate merely some embodiments of the present disclosure, and those of ordinary skill in the art can still derive other accompanying drawings from these accompanying drawings without creative efforts.

FIG. 1 is a schematic diagram of a communication system in the related art;

FIG. 2 is a schematic diagram of a communication system in the related art;

FIG. 3 is a schematic diagram of a communication system in the related art;

FIG. 4 is a schematic diagram of a transparent load NTN scenario in the related art;

FIG. 5 is a schematic diagram of a regenerative load NTN scenario in the related art;

FIG. 6 is a schematic timing diagram of a multi-round trip time (multi-RTT) positioning method in the related art;

FIG. 7 is a schematic timing diagram of a multi-RTT positioning method in the related art;

FIG. 8 is a schematic diagram of a principle of a multi-RTT positioning method in the related art;

FIG. 9 is a schematic timing diagram of a multi-RTT positioning method in the related art;

FIG. 10 is a schematic diagram of a virtual TRP-based positioning system according to some embodiments of the present disclosure;

FIG. 11 is a flowchart of a wireless communication method for positioning according to another embodiment of the present disclosure;

FIG. 12 is a flowchart of a wireless communication method for positioning according to another embodiment of the present disclosure;

FIG. 13 is a schematic timing diagram of a wireless communication method for positioning according to another embodiment of the present disclosure;

FIG. 14 is a schematic timing diagram of a wireless communication method for positioning according to another embodiment of the present disclosure;

FIG. 15 is a schematic diagram of a scenario of a wireless communication method for positioning according to another embodiment of the present disclosure;

FIG. 16 is a schematic timing diagram of a wireless communication method for positioning according to another embodiment of the present disclosure;

FIG. 17 is a structural block diagram of a wireless communication device for positioning according to some embodiments of the present disclosure;

FIG. 18 is a structural block diagram of a wireless communication device for positioning according to another embodiment of the present disclosure; and

FIG. 19 is a structural block diagram of a communication device according to some embodiments of the present disclosure.

### DETAILED DESCRIPTION

For clearer descriptions of the objectives, technical solutions, and advantages of the present disclosure, embodiments of the present disclosure are further described in detail hereinafter with reference to the accompanying drawings.

Exemplary embodiments are described herein in detail, and examples of the embodiments are represented in the accompanying drawings. In the following description related to the accompanying drawings, the same numerals in the different accompanying drawings indicate the same or similar elements unless otherwise indicated. The embodiments described in the following exemplary embodiments do not represent all embodiments consistent with the present disclosure. Rather, the embodiments are only examples of apparatuses and methods consistent with some aspects of this application as described in the appended claims.

The terms used in the disclosure is configured merely for the purpose of describing particular embodiments and is not intended to limit the present disclosure. The singular forms of “a,” “an,” “said,” and “the” in this disclosure and the appended claims are also intended to include the majority form, unless the context clearly indicates other meanings. It should also be understood that the term “and/or” herein refers to including any or all possible combinations of one or more of the associated listed items.

It should be understood that while the terms first, second, third, or the like are used in the present disclosure to describe various pieces of information, such information should not be limited to these terms. These terms are used only to distinguish one type of information from one another. For example, without departing from the scope of the present disclosure, the first information may be referred to as the second information, and similarly, the second information may also be referred to as the first information. Depending on the context, as used herein, the phrase “if” may be interpreted as “in the case that,” “when . . . ,” or “in response to determining”.

In the related art, uplink positioning technology or downlink positioning technology, or the like, is employed to position a terminal device. In the case that the uplink positioning technology is employed for positioning, the terminal device transmits an uplink positioning signal to an access network device, the access network device measures the uplink positioning signal and transmits the measurement information to a core network device, and the core network device performs the positioning calculation. In the case that the downlink positioning technology is employed for positioning, the terminal device receives the downlink positioning signal transmitted by the access network device and measures the downlink positioning signal, the terminal device performs the positioning calculation or transmits measurement information to the core network device, and the core network device performs the positioning calculation.

However, the above techniques are designed based on terrestrial network (TN) and are not applicable to non-terrestrial network (NTN).

First, the related art involved in the embodiments of the present disclosure is described:

### Network Scenarios

Communication system scenarios involve a terrestrial network (TN) and a non-terrestrial network (NTN). The NTN generally employs satellite communications to provide communication services to terrestrial users. The NTN systems currently include new radio (NR)-NTN and Internet of things (IoT)-NTN systems.

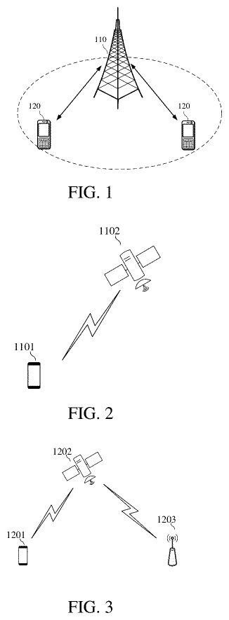

Exemplarily, FIG. 1 is a schematic diagram of an architecture of a communication system 100 according to some embodiments of the present disclosure. As shown in FIG. 1, the communication system includes a network device 110. The network device 110 communicates with a terminal device 120 (or referred to as a communication terminal device, or a terminal). The network device 110 is capable of providing communication coverage for a specific geographic region and communicating with terminal devices within the coverage.

FIG. 1 exemplarily illustrates a network device and two terminal devices. In some embodiments, the communication system includes a plurality of network devices and other quantities of terminal devices within the coverage of each of plurality of the network devices, which is not limited in the present disclosure.

Exemplarily, FIG. 2 is a schematic diagram of an architecture of another communication system 200 according to some embodiments of the present disclosure. As shown in FIG. 2, the communication system 200 includes a terminal device 1101 and a satellite 1102, and wireless communication may be conducted between the terminal device 1101 and the satellite 1102. The network formed between the terminal device 1101 and the satellite 1102 may also be referred to as an NTN. In the architecture of the communication system 200 shown in FIG. 2, the satellite 1102 has the function of a base station, and the terminal device 1101 is capable of directly communicating with the satellite 1102. In the architecture of the communication system 200, the satellite 1102 is referred to as a network device. In some embodiments, the communication system 200 includes a plurality of network devices 1102 and other quantities of terminal devices within the coverage of each of the plurality of network devices 1102, which is not limited in the present disclosure.

Exemplarily, FIG. 3 is a schematic diagram of an architecture of another communication system 300 according to some embodiments of the present disclosure. As shown in FIG. 3, the communication system 300 includes a terminal device 1201, a satellite 1202, and a base station 1203, wireless communication may be conducted between the terminal device 1201 and the satellite 1202, and communication may be conducted between the satellite 1202 and the base station 1203. The network formed between the terminal device 1201, the satellite 1202, and the base station 1203 is also referred to as an NTN. In the architecture of the communication system 300 shown in FIG. 3, the satellite 1202 does not have the function of a base station, and communication between the terminal device 1201 and the base station 1203 requires to be relayed via the satellite 1202. In the architecture of the communication system 300, the base station 1203 is referred to as a network device. In some embodiments, the communication system 300 includes a plurality of network devices 1203 and other quantities of terminal devices within the coverage of each of the plurality of network device 1203, which is not limited in the present disclosure.

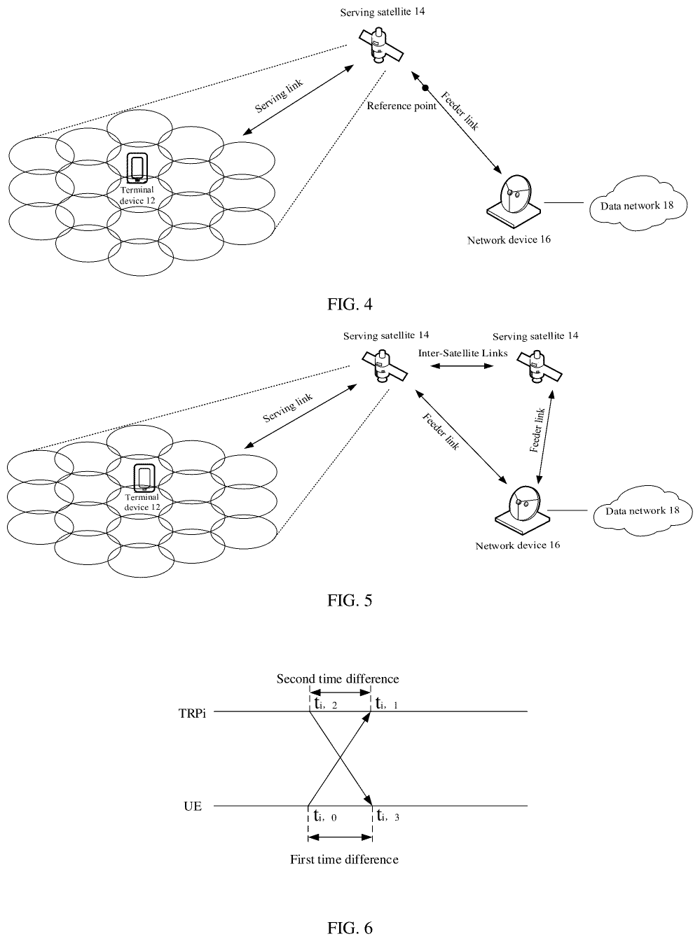

In order to ensure satellite coverage and enhance the system capacity of the entire satellite communication system, the satellite employs multiple beams to cover the ground, and a satellite forms dozens or even hundreds of beams to cover the ground. The satellite beam covers a ground region of dozens to hundreds of kilometers in diameter. At least two NTN scenarios are present, i.e., a transparent load NTN scenario shown in FIG. 4 and a regenerative load NTN shown in FIG. 5. The NTN network includes the following network elements:
one or more gateways, configured to connect the satellite to the terrestrial public network;
a feeder link, used for communication between the gateway and the satellite;
a serving link, used for communication between terminals and satellites;
a satellite, categorized into two types, i.e., transparent load and regenerative load based on the functions provided by the satellite;
transparent load, only providing radio frequency filtering, frequency conversion and amplification, and only providing transparent forwarding of signals and not changing the forwarded waveform signals;
regenerative load, in addition to providing radio frequency filtering, frequency conversion and amplification, providing demodulation/decoding, routing/conversion, encoding/modulation functions, and having some or all of the functions of a base station; and
an inter-satellite link (ISL), present in regenerative load scenarios.

### Synchronization in NR-NTN and IoT-NTN Systems

In an NTN system, the network device needs to transmit synchronization auxiliary information to the terminal device. The synchronization auxiliary information assists the terminal device to complete time domain synchronization and/or frequency domain synchronization. The synchronization auxiliary information indicates at least one of serving satellite ephemeris information, a public TA value parameter, reference instant indication information (epoch time, for determining an t0 instant), or a target timer duration.

The terminal device completes the corresponding time domain synchronization and/or frequency domain synchronization based on the synchronization auxiliary information and its own global navigation satellite system (GNSS) capabilities. The terminal device acquires at least one of a position of the terminal device, a time reference, or a frequency reference based on its GNSS capabilities. Based on the above information and the information acquired based on the synchronization auxiliary information, the terminal device acquires timing and/or frequency offset, and applies timing advance (TA) compensation and/or frequency offset adjustment in an idle state, an inactive state, or a connected state.

Specifically, a value of the TA in the case that the terminal device transmits an uplink channel or an uplink signal is:

$${T}_{TA} = ( {N}_{TA} + {N}_{TA , offset} + {N}_{TA , adj}^{common} + {N}_{TA , adj}^{UE} ) {T}_{c}$$

wherein N_{TA} represents the TA value indicated by the network device, e.g., the TA value issued over a TA command, and in the case that the uplink channel or the uplink signal includes a physical random access channel (PRACH) or MsgA (processing message A in a two-step random access procedure) transmission, N_{TA} takes the value of 0.

N_{TA,offset} is equal to the value in the related art, e.g., is determined based on the coexistence of long term evolution (LTE) or NR with the fabric band.

N_{TA,adj}^{common} is acquired based on a public TA value parameter (e.g., at least one of a public timing value, a public timing value offset, or a change rate of the public timing value offset) of a higher-layer configuration. In the case that the public TA value parameter is not configured, N_{TA,adj}^{common} takes the value of 0. In some cases, N_{TA,adj}^{common} is also referred to as the feeder link TA value.

N_{TA,adj}^{UE} is calculated based on the position of the terminal device and the serving satellite ephemeris information of a higher-layer configuration. In the case that the serving satellite ephemeris information is not configured, N_{TA,adj}^{UE} takes the value of 0. In some cases, N_{TA,adj}^{UE} is also referred to as the serving link TA value.

T_{c} indicates the sampling interval unit, T_{c}=1/(480*1000*4096).

Because the satellite is moving, the synchronization auxiliary information changes with the change of time. For example, the serving satellite ephemeris information changes with the change of time, and the parameters of the public TA value includes: the public timing value, the offset value of the public timing value (for example, the first-order derivative of the public timing value), the change rate of the offset value of the public timing value (for example, the second-order derivative of the public timing value), and the like. The terminal device determines the serving satellite ephemeris information at different instants and the public TA values at different instants based on the synchronization auxiliary information to acquire the TA values at different instants.

That is, in the NTN system, the difference between the TA values corresponding to different instants is great.

### Positioning Techniques in NR Systems

In the NR systems, the supported positioning method includes a downlink time difference of arrival (DL-TDOA) positioning method, an uplink time difference of arrival (UL-TDOA) positioning method, and a multi-round trip time (multi-RTT) positioning method, and the like. The present disclosure is applicable to methods including, but not limited to, the above methods, for example, the present disclosure is applicable to the multi-RTT positioning method.

The basic principle of the multi-RTT positioning method is to estimate the position information of the terminal device by corresponding the round-trip time measurement result to the distance di between the terminal device and the network node TRP i. The multi-RTT positioning method is based on the bidirectional transmission of the measurement of a positioning signal (or a positioning reference signal) between the terminal device and the network node TRP. That is, the following two processes are required simultaneously: the network node TRP transmits downlink positioning signals and the terminal device measures the downlink positioning signals, and the terminal device transmits uplink positioning signals and the network node TRP measures the uplink positioning signals.

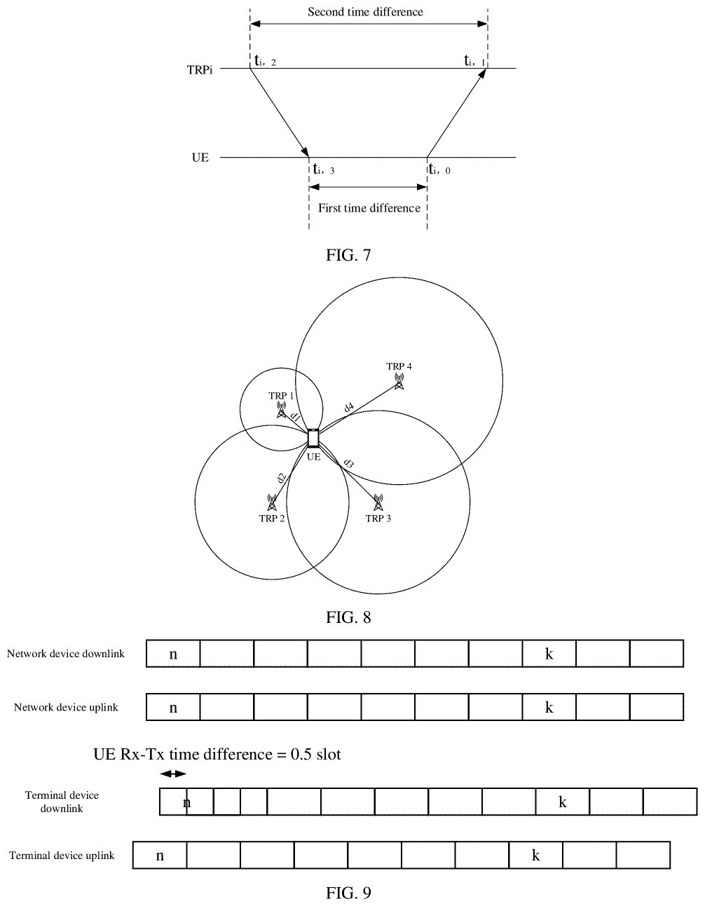

Referring to FIGS. 6 and 7, the terminal device calculates a UE Rx-Tx time difference, also referred to as a first time difference, based on an instant t_{i,3} when the terminal device receives the downlink positioning signal and an instant t_{i,0} when the terminal device transmits the uplink positioning signal. τ_{UE,i}^{Rx} indicates the receive timing error in receiving the downlink positioning signal by the terminal device from the network node TRP i (i=1, 2, . . . M), and τ_{UE,i}^{Tx} indicates the transmit timing error in transmitting the uplink positioning signal by the terminal device to the network node TRP i:

$${TD}_{UE Rx - Tx}^{i} = {t}_{i , 3} - {t}_{i , 0} = {\tilde{t}}_{i , 3} + {τ}_{UE , i}^{Rx} - {\tilde{t}}_{i , 0} - {τ}_{UE , i}^{Tx} + {n}_{UE , i} \qquad ( I )$$

The network node TRP i calculates the gNB Rx-Tx time difference based on the instant of receiving the uplink positioning signal and the instant of transmitting the downlink positioning signal. τᵢ^{Rx} indicates the receive timing error of the network node TRP i (i=1, 2, . . . M), and τ_{UE,i}^{Tx} indicates the transmit timing error of network node TRP i:

$${TD}_{gNB Rx - Tx}^{i} = {t}_{i , 1} - {t}_{i , 2} = {\tilde{t}}_{i , 1} + {τ}_{i}^{Rx} - {\tilde{t}}_{i , 2} - {τ}_{i}^{Tx} + {n}_{i} \qquad ( II )$$

The RTT estimated value is acquired by adding Equations (I) and (II) and assuming that the receive timing error and the transmit timing error of the network node TRP i are identical (τᵢ^{Rx}=τᵢ^{Tx}) and that the receive timing error and the transmit timing error between the terminal device and the network node TRP i are identical (τ_{UE,i}^{Rx}=τ_{UE,i}^{Tx})

$${RTT}_{i} = ( {\tilde{t}}_{i , 1} - {\tilde{t}}_{i , 0} ) + ( {\tilde{t}}_{i , 3} - {\tilde{t}}_{i , 2} ) + ( {n}_{UE , i} + {n}_{i} ) \qquad ( III )$$

Considering that the distance of uplink or downlink transmission between the network node TRP i and the terminal device is di, the Equation (III) can be written as:

$$\frac{{RTT}_{i}}{2} = \frac{\sqrt[2]{{( {x}_{i} - {x}_{UE} )}^{2} + {( {y}_{i} - {y}_{UE} )}^{2} + {( {z}_{i} - {z}_{UE} )}^{2}}}{c} + \frac{{n}_{UE , i} + {n}_{i}}{2} \qquad ( IV )$$

Each equation in the Equations (IV) can be seen as a circle with TRP i as the center and

$$\frac{{RTT}_{i}}{2} \times c$$

as the radius. Therefore, the physical meaning of the multi-RTT positioning method can be understood intuitively with reference to FIG. 8. The corresponding circle is drawn with each network node TRP i as the center, and the location where these circles cross is the location of the terminal device estimated by the multi-RTT positioning method. Because of the influence of factors such as the estimation error nᵢ, these circles usually do not perfectly cross at a point, but cross within a small range.

Exemplarily, the network devices described above are connected to a location management function (LMF) network element in the core network, and may include other physical devices. Optionally, the LMF network element includes a location server, the location server is implemented as any of a location management function (LMF), an enhanced serving mobile location center (E-SMLC), secure user plane location (SUPL), or a secure user plane location platform (SUPL SLP).

In the multi-RTT positioning method, the terminal device estimates the UE Rx-Tx time difference based on the reception of the downlink positioning signal and the transmission of the uplink positioning signal, and reports the UE Rx-Tx time difference corresponding to each network device (or virtual TRP) to the LMF. The network device estimates the gNB Rx-Tx time difference based on the reception of the uplink sounding reference signal (SRS) and the transmission of the downlink positioning reference signal (PRS), and reports the gNB Rx-Tx time difference to the LMF. Based on the UE Rx-Tx time difference and the gNB Rx-Tx time difference of each TRP, the LMF can acquire the distance between each TRP and the user equipment (UE), and then acquires the position information of the terminal device by performing solution using the position information of each TRP.

The UE Rx-Tx time difference is defined as T_{UE-RX}−T_{UE-RX}. T_{UE-RX} represents a receive timing of the terminal device receiving a downlink subframe #i from a TRP, and the receive timing is determined based on the first arrival path of the received signal. T_{UE-RX} represents a transmit timing of the terminal device transmitting an uplink subframe #j to the TRP, and the uplink subframe #j is a subframe that is closest to the downlink subframe #i in time. That is, the UE Rx-Tx time difference is acquired based on the timing of the actual receiving subframe of the signal and the timing of the transmitting subframe closest in time to that receiving subframe. It is to be noted that a plurality of downlink SRS resources are used for determining a first arrival path corresponding to the start position of the downlink subframe #i.

The gNB Rx-Tx time difference is defined as T_{gNB-RX}−T_{gNB-RX}. T_{gNB-RX} represents the receive timing of the uplink subframe #i received from the network device, the uplink subframe #i is an uplink subframe associated with the terminal device and including SRS, and the receive timing is determined based on the first arrival path of the received signal. T_{gNB-RX} represents the transmit timing of the downlink subframe #j transmitted to the terminal device from the network device, and the downlink subframe #j is a subframe that is closest to the uplink subframe #i in time. That is, the gNB Rx-Tx time difference is acquired based on the timing of the actual receiving subframe of the signal and the timing of the transmitting subframe closest in time to that receiving subframe. It is noted that a plurality of SRS resources used for positioning are used to determine the start position of the uplink subframe #i including the SRS. Taking FIG. 9 as an example, the gNB Rx-Tx time difference takes the value of about 0, the UE Rx-Tx time difference is about 0.5 subframe, and the RTT is about 0.5 subframe.

In the TN networks, because the round-trip propagation delay of the positioning signal is small and usually not larger than 1 subframe, the time difference of the measurement information reported by the terminal device is limited to one subframe. In NTN networks; however, the larger signal propagation delay causes the above assumption that the RTT delay in the TN networks is not greater than one subframe to be no longer applicable to NTN networks.

It should be noted that all signal transmissions include a plurality of paths, because the transmitting signal meets various obstacles during transmission, resulting in refraction, reflection, or the like, of the signal in addition to the direct radiation, the signal arrives at the receive terminal through a number of different paths, and each path arrives at the receive terminal at a different time. The first path is the earliest arrival path.

In the NTN networks, in order to estimate the position of the terminal device by using the multi-RTT positioning method, the positions of the serving satellite at different instants are equated to different TRPs. The TRPs are referred to as virtual TRPs in some embodiments of the present disclosure, i.e., each of the virtual TRPs corresponds to the position of the serving satellite at one instant. The position of the terminal device is estimated based on the relative distances between the positions of the serving satellite at different instants and the terminal device. Schematically, the serving satellite position at an instant ti is regarded as a TRP i, and the distance between the TRP i and the terminal device is di, wherein i=0, 1, 2, . . . , M-1.

That is, the embodiments of the present disclosure introduce TRP groups (which are also referred to as virtual TRP groups in some embodiments). Each of the TRP groups includes TRPs corresponding to at least two different instants (or corresponding to the serving satellite position at two different instants), the reception of downlink positioning signals belonging to the same TRP group corresponds a sufficiently small receive timing error (e.g., less than a threshold or negligible within a specific error range), and/or the transmission of the uplink positioning signals belonging to the same TRP group corresponds a sufficiently small transmit timing error (e.g., less than a threshold or negligible within a specific error range), and/or the measurement result belonging to the same TRP group corresponds to a sufficiently small measurement timing error (e.g., less than a threshold or negligible within a specific error range), such that a higher positioning accuracy is acquired. Alternatively, the TRP group corresponds to a continuous period of time, such as a first duration, during which the timing error in receiving the downlink positioning signal by the terminal device is sufficiently small, and/or the timing error in transmitting the uplink positioning signal by the terminal device is sufficiently small, and/or the timing error in transmitting the downlink positioning signal by the network device or the serving satellite is sufficiently small, and/or the timing error in receiving the uplink positioning signal by the network device or the serving satellite is sufficiently small.

For example, the TRP group includes TRPs corresponding to two different instants. The TRP group i includes a TRP i corresponding to the serving satellite position at the instant ti and a TRP i′ corresponding to the serving satellite position at the instant ti′, wherein the distance between the TRP i and the terminal device is di, and the distance between the TRP P and the terminal device di′, wherein i=0, 1, 2, . . . , M-1. In each TRP group, TRP i is regarded as a reference TRP.

In the multi-RTT positioning method, the TRP group i corresponds to the reception of a downlink positioning signal, and/or the TRP group i corresponds to the transmission of an uplink positioning signal.

FIG. 10 illustrates a block diagram of a positioning system according to some embodiments of the present disclosure. The positioning system is applied to the NTN network including the serving satellite, and the positioning system includes a terminal device 12, a serving satellite 14, and a network device 16. Optionally, the positioning system further includes an LMF 18.

The serving satellite 14 forms at least one virtual TRP, and/or includes at least one virtual TRP group. The virtual TRP group includes at least one virtual TRP, and the number of virtual TRPs in each virtual TRP group may be the same or different.

In some embodiments, a virtual TRP is also referred to as a TRP, and a virtual TRP group is also referred to a TRP group.

As schematically shown in FIG. 10, the virtual TRPs in the positioning system are a TRP 0 (corresponding to the position of the serving satellite at the instant t0), TRP 0′ (corresponding to the serving satellite position at the instant t0′), a TRP 1 (corresponding to the serving satellite position at the instant t1), a TRP 1′ (corresponding to the serving satellite position at the instant t1), a TRP 2 (corresponding to the serving satellite position at the instant t2), a TRP 2′ (corresponding to the serving satellite position at the instant t2′), a TRP 3 (corresponding to the serving satellite position at the instant t3), and TRP 3′ (corresponding to the serving satellite position at the instant t3′).

Optionally, the TRP 0 and the TRP 0′ form a virtual TRP group 0, the TRP 1 and the TRP 1′ form a virtual TRP group 1, the TRP 2 and the TRP 2′ form a virtual TRP group 2, and the TRP 3 and the TRP 3′ form a virtual TRP group 3.

The present embodiment is schematically illustrated as an example of a positioning system including four virtual TRP groups, wherein each of the virtual TRP groups includes two virtual TRPs. The positioning system performs positioning based on M downlink positioning signal resources and/or N uplink positioning signal resources, wherein M and N are positive integers.

The M downlink positioning signal resources, and/or the N uplink positioning signal resources satisfy at least one of: the M downlink positioning signal resources having a one-to-one correspondence relationship with serving satellite positions of M instants; the M downlink positioning signal resources having a one-to-one correspondence relationship with the M virtual TRPs; the serving satellite positions of M instants having a one-to-one correspondence relationship with M virtual TRPs; the N uplink positioning signal resources having a one-to-one correspondence relationship with serving satellite positions of N instants; the N uplink positioning signal resources having a one-to-one correspondence relationship with N virtual TRPs; or the serving satellite positions of N instants having a one-to-one correspondence relationship with N virtual TRPs;

In the case that M is an integer greater than 1, the M instants are different instants; and in the case that N is an integer greater than 1, the N instants are different instants.

In some embodiments, the positioning system uses a first positioning signal resource group, wherein the first positioning signal resource group includes the M downlink positioning signal resources and/or N uplink positioning signal resources; or the positioning system includes a first virtual TRP group, wherein the first virtual TRP group includes the M virtual TRPs and/or the N virtual TRPs; or the positioning system includes a first serving satellite position group, wherein the first serving satellite position group includes the serving satellite positions of the M instants and/or the serving satellite positions of the N instants.

In some embodiments, a transmit timing error of each of downlink positioning signals corresponding to the M downlink positioning signal resources is within a second error range, and/or a receive timing error of each of the downlink positioning signals corresponding to the M downlink positioning signal resources is within a first error range; a transmit timing error of each of M downlink positioning signals corresponding to the M virtual TRPs is within the second error range, and/or a receive timing error of each of the downlink positioning signals corresponding to the M virtual TRPs is within the first error range; or a transmit timing error of each of downlink positioning signals corresponding to the serving satellite positions of the M instants is within the second error range, and/or a receive timing error of each of the downlink positioning signals corresponding to the serving satellite positions of the M instants is within the first error range.

In some embodiments, a transmit timing error of each of uplink positioning signals corresponding to the N uplink positioning signal resources is within a third error range, and/or a receive timing error of each of the uplink positioning signal corresponding to the N uplink positioning signal resources is within a fourth error range; a transmit timing error of each of uplink positioning signals corresponding to the N virtual TRPs is within the third error range, and/or a receive timing error of each of the uplink positioning signals corresponding to the N virtual TRPs is within the fourth error range; or a transmit timing error of each of uplink positioning signals corresponding to the serving satellite positions of the N instants is within the third error range, and/or a receive timing error of each of the uplink positioning signals corresponding to the serving satellite positions of the N instants is within the fourth error range.

In some embodiments, an error of a sum of a receive timing error of a downlink positioning signal corresponding to a downlink positioning signal resource in the first positioning signal resource group and a transmit timing error of a uplink positioning signal corresponding to a uplink positioning signal resource is within a fifth error range, and/or an error of a sum of a transmit timing error of the downlink positioning signal corresponding to the downlink positioning signal resource in the first positioning signal resource group and a receive timing error of the uplink positioning signal corresponding to the uplink positioning signal resource is within a sixth error range; an error of a sum of a receive timing error of each of downlink positioning signals corresponding to M virtual TRPs in a first virtual TRP group and a transmit timing error of each of uplink positioning signals corresponding to N virtual TRPs is within the fifth error range, and/or an error of a sum of a transmit timing error of each of the downlink positioning signals corresponding to the M virtual TRPs in the first virtual TRP group and a receive timing error of each of the uplink positioning signals corresponding to the N virtual TRPs is within the sixth error range; or an error of a sum of a receive timing error of each of downlink positioning signals corresponding to the serving satellite positions of the M instants in a first serving satellite position group and a transmit timing error of each of uplink positioning signals corresponding to the serving satellite positions of the N instants is within the fifth error range, and/or an error of a sum of a transmit timing error of each of the downlink positioning signals corresponding to the serving satellite positions of the M instants in the first serving satellite position group and a receive timing error of each of the uplink positioning signals corresponding to the serving satellite positions of the N instants is within the sixth error range.

In some embodiments of the present disclosure, the first error range indicates that the error of the first error range is sufficiently small, e.g., less than a threshold or negligible within a specific error range.

In some embodiments of the present disclosure, the second error range indicates that the error of the second error range is sufficiently small, e.g., less than a threshold or negligible within a specific error range.

In some embodiments of the present disclosure, a third error range indicates that the error of the third error range is sufficiently small, e.g., less than a threshold or negligible within a specific error range.

In some embodiments of the present disclosure, a fourth error range indicates that the error of the fourth error range is sufficiently small, e.g., less than a threshold or negligible within a specific error range.

In some embodiments of the present disclosure, a fifth error range indicates that the error of the fifth error range is sufficiently small, e.g., less than a threshold or negligible within a specific error range.

In some embodiments of the present disclosure, a sixth error range indicates that the error of the sixth error range is sufficiently small, e.g., less than a threshold or negligible within a specific error range.

The technical solutions according to the embodiments of the present disclosure are applicable to various communication systems, such as global system of mobile communication (GSM) systems, code-division multiple access (CDMA) systems, wideband code-division multiple access (WCDMA) systems, general packet radio service (GPRS), long-term evolution (LTE) systems, LTE frequency division duplex (FDD) systems, LTE time division duplex (TDD) systems, advanced long-term evolution (LTE-A) systems, universal mobile telecommunication system (UMTS), worldwide interoperability for microwave access (WiMAX) communication systems, 5^{th} generation (5G) mobile communication systems, New Radio (NR) systems, evolved system of the NR systems, an LTE-based access to unlicensed spectrum (LTE-U) system on unlicensed spectrum, an NR-based access to unlicensed spectrum (NR-U) systems, TN systems, an NTN systems, wireless local area networks (WLAN), wireless fidelity (Wi-Fi), cellular IoT systems, cellular passive IoT systems, and is also applicable to subsequent evolutionary systems of 5G NR systems, beyond 5th generation (B5G) mobile communication systems, 6G, and subsequent evolutionary systems. In some embodiments of the present application, “NR” is also referred to as a 5G NR system or a 5G system. The 5G mobile communication system includes non-standalone (NSA) and/or standalone (SA).

The technical solutions according to the embodiments of the present disclosure is also applicable to machine-type communications (MTC), long-term evolution-machine (LTE-M), and device-to-device (D2D) networks, machine-to-machine (M2M) networks, IoT networks, or other networks. For example, the IoT network includes a connected car network. The communication methods in the connected vehicle system are collectively referred to as vehicle to other devices (V2X, X representing anything). For example, the V2X includes vehicle to vehicle (V2V) communication, vehicle-to-infrastructure (V2I) communication, vehicle-to-pedestrian (V2P) communication, or vehicle-to-network (V2N) communication, and the like.

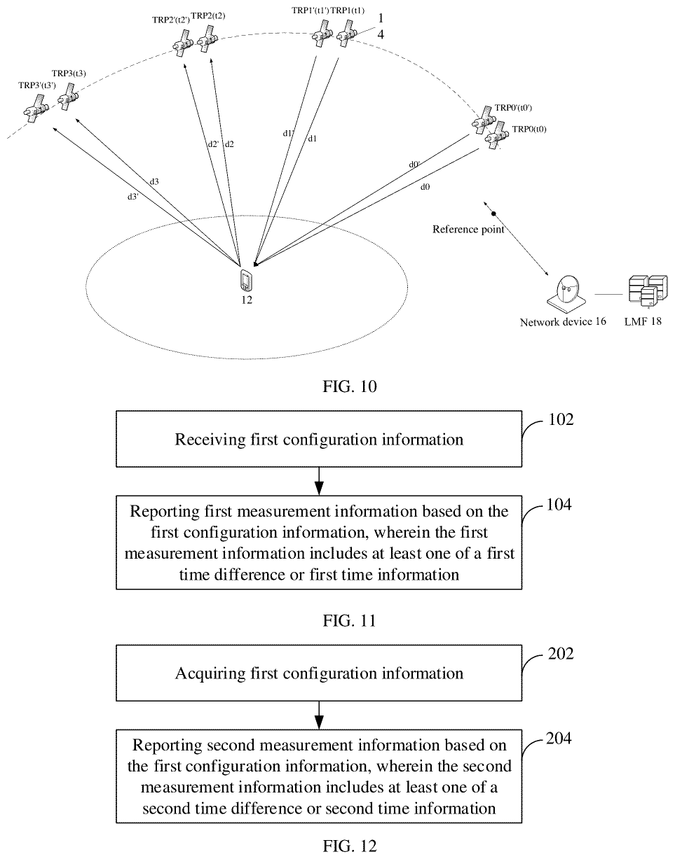

FIG. 11 is a flowchart of a wireless communication method for positioning according to some embodiments of the present disclosure. This embodiment is illustrated by an example where the method is performed by a terminal device. The terminal device is a terminal device in the NTN system. The method includes the follow processes.

In 102, first configuration information is received.

The first configuration information is used for determining (or configuring) M downlink positioning signal resources and/or N uplink positioning signal resources, wherein M and N are positive integers. The first configuration information includes one or more pieces of configuration information.

In some embodiments, the terminal device receiving the first configuration information includes: receiving the first configuration information transmitted by the network device; and/or receiving the first configuration information transmitted by the LMF. That is, the first configuration information is configured by the network device and/or the LMF. In the case that the first configuration information is one piece of information, the first configuration information is configured by the network device or configured by the LMF. In the case that the first configuration information is more than one pieces of information, the first configuration information is configured collaboratively by the network device and the LMF.

In some embodiments, the one piece of first configuration information is used for simultaneously determining the M downlink positioning signal resources and the N uplink positioning signal resources. In some embodiments, the first configuration information is at least two pieces of information, wherein one of the two pieces of first configuration information is used for determining the M downlink positioning signal resources, and the other of the two pieces of first configuration information is used for determining the N uplink positioning signal resources.

In some embodiments, the M downlink positioning signal resources have a one-to-one correspondence relationship with serving satellite positions of M instants, or the M downlink positioning signal resources have a one-to-one correspondence relationship with M virtual TRPs. In some embodiments, the N uplink positioning signal resources have a one-to-one correspondence relationship with the serving satellite positions of N instants, or the N uplink positioning signal resources have a one-to-one correspondence relationship with the N virtual TRPs. The M instants are different instants in the case that M is an integer greater than 1, and the N instants are different instants in the case that N is an integer greater than 1.

In some embodiments, the one or more first configuration information is used for determining P downlink positioning signal resource groups, and/or Q uplink positioning signal resource groups. Each downlink positioning signal resource group of the P downlink positioning signal resource groups corresponds to a virtual TRP group; and each uplink positioning signal resource group of the Q uplink positioning signal resource groups corresponds to a virtual TRP group. The first downlink positioning signal resource group of the P downlink positioning signal resource groups includes M downlink positioning signal resources, and the first uplink positioning signal resource group of the Q uplink positioning signal resource groups includes N uplink positioning signal resources.

In some embodiments, the one or more pieces of first configuration information are used for determining R positioning signal resource groups. Each of the R positioning signal resource groups corresponds to a virtual TRP group. The first positioning signal resource group of the R positioning signal resource groups includes M downlink positioning signal resources and N uplink positioning signal resources.

In 104, first measurement information is reported based on the first configuration information, wherein the first measurement information includes at least one of a first time difference or first time information.

The first measurement information includes related measurement information configured to implement multi-RTT positioning, serving satellite position positioning corresponding to a plurality of instants, or multi-TRP positioning. The first measurement information is related to a receive timing of the downlink positioning signal and/or a transmit timing of the uplink positioning signal. In some embodiments, the first measurement information is configured to calculate a distance or an RTT between the terminal device and the virtual TRP.

In some embodiments, the method further includes: receiving at least one downlink positioning signal of the M downlink positioning signals based on the M downlink positioning signal resources; and/or transmitting at least one uplink positioning signal of the N uplink positioning signals based on the N uplink positioning signal resources.

In some embodiments, receiving the at least one downlink positioning signal of the M downlink positioning signals based on the M downlink positioning signal resources includes: receiving the M downlink positioning signals based on the M downlink positioning signal resources. In some embodiments, transmitting the at least one uplink positioning signal of the N uplink positioning signals based on the N uplink positioning signal resources includes transmitting the N uplink positioning signals.

In some embodiments, the first time difference is determined based on a receive timing of the at least one group of downlink positioning signals and a transmit timing of the uplink positioning signals. For example, the first time difference is a difference between the receive timing of the downlink positioning signal and the transmit timing of the uplink positioning signal.

### First Time Difference

The first time difference is a difference between the receive timing of the downlink positioning signal and the transmit timing of the uplink positioning signal. For example, the first time difference is a UE Rx-Tx time difference. Optionally, the first time difference is a positive or negative number or 0.

In some embodiments, the unit of the first time difference is a slot, a subframe or a millisecond or a microsecond or a sampling interval unit Tc, or the like, which is not limited in the present disclosure.

### First Downlink Time Unit

In some embodiments, the receive timing of the downlink positioning signal is a receive timing of the first downlink time unit, or the receive timing of the downlink positioning signal is a universal time coordinated (UTC) time corresponding to the receive timing of the first downlink time unit.

The first downlink time unit includes at least one time unit corresponding to at least one downlink positioning signal resource of the M downlink positioning signal resources.

In some embodiments, the first downlink time unit includes at least one of: a time unit corresponding to a first downlink positioning signal resource of the M downlink positioning signal resources; a time unit corresponding to a last downlink positioning signal resource of the M downlink positioning signal resources; or a time unit of the M downlink positioning signal resources configured to determine the receive timing of the downlink positioning signal.

By way of example but not limitation, the first downlink time unit is a time unit determined by the terminal device itself.

### First Uplink Time Unit

In some embodiments, the transmit timing of the uplink positioning signal is a transmit timing of the first uplink time unit, or the transmit timing of the uplink positioning signal is a UTC time corresponding to the transmit timing of the first uplink time unit.

The first uplink time unit includes at least one time unit corresponding to at least one uplink positioning signal resource of the N uplink positioning signal resources.

In some embodiments, the first uplink time unit includes at least one of: a time unit corresponding to a first uplink positioning signal resource of the N uplink positioning signal resources; a time unit corresponding to a last uplink positioning signal resource of the N uplink positioning signal resources; or a time unit of the N uplink positioning signal resources configured to determine the transmit timing of the uplink positioning signal.

By way of example but not limitation, the first uplink time unit is a time unit determined by the terminal device.

In some embodiments, the time unit is at least one of a subframe, a slot, a frame, a symbol group, or a symbol.

In some embodiments, the first time difference is defined as T_{UE-RX}-T_{UE-RX}. Alternatively, the first time difference is defined as a time difference between the receive timing of the terminal device receiving the first downlink time unit #i and the transmit timing of the terminal device transmitting the first uplink time unit #j.

Optionally, T_{UE-RX} represents the receive timing of the terminal device receiving the first downlink time unit #i, or T_{UE-RX} represents the UTC time corresponding to the receive timing of the terminal device receiving the first downlink time unit #i. Optionally, the receive timing is determined based on a first arrival path of the received signal. Optionally, the receive timing (e.g., the first arrival path corresponding to the start position of the first downlink time unit #i) is determined based on one or more downlink positioning signal resources (e.g., downlink PRS resources). Optionally, the first downlink time unit #i includes at least one time unit corresponding to the M downlink positioning signal resources. For example, the first downlink time unit #i includes a time unit in which the first downlink positioning signal resource of the M downlink positioning signal resources is located. For example, the first downlink time unit #i includes a time unit in which the last downlink positioning signal resource of the M downlink positioning signal resources is located. As another example, the first downlink time unit #i is determined by the terminal device from the time units in which the M downlink positioning signal resources are located.

Optionally, T_{UE-RX} represents a transmit timing of the terminal device transmitting the first uplink time unit #j. Alternatively, T_{UE-RX} represents a UTC time corresponding to the transmit timing of the terminal device transmitting the first uplink time unit #j. Optionally, the first uplink time unit #j includes at least one time unit corresponding to the N uplink positioning signal resources. For example, the first uplink time unit #j includes a time unit in which the first uplink positioning signal resource of the N uplink positioning signal resources is located. For example, the first uplink time unit #j includes a time unit in which the last uplink positioning signal resource of the N uplink positioning signal resources is located. For example, the first uplink time unit #j is determined by the terminal device from the time units in which the N uplink positioning signal resources are located.

In some embodiments, it is also considered that the first time difference, such as the UE Rx-Tx time difference, is acquired based on the signal actual receive time unit timing and the signal actual transmission time unit timing.

### First Time Information

In some embodiments, the first time information includes: information related to the receive timing of the downlink positioning signal and/or information related to the transmit timing of the uplink positioning signal.

In some embodiments, the first timing information includes at least one of: a first downlink time unit; a first uplink time unit; a UTC time corresponding to the first downlink time unit; or a UTC time corresponding to the first uplink time unit; wherein the first downlink time unit is configured to determine a receive timing of the downlink positioning signal, and the first uplink time unit is configured to determine a transmit timing of the uplink positioning signal.

In some embodiments, the first time information includes at least one of: a first downlink time unit #i, a first uplink time unit #j, a UTC time corresponding to the first downlink time unit #i, or a UTC time corresponding to the first uplink time unit #j.

Optionally, the first time information includes the first downlink time unit #i, which indicates that the first time information includes start position information of the first downlink time unit #i, or the first time information includes end position information of the first downlink time unit #i.

Optionally, the first time information includes a first uplink time unit #j, which indicates that the first time information includes start position information of the first uplink time unit #j, or the first time information includes end position information of the first uplink time unit #j.

Optionally, the first time information includes the UTC time corresponding to the first downlink time unit #i, which indicates that the first time information includes the UTC time corresponding to the start position of the first downlink time unit #i, or the first time information includes the UTC time corresponding to the end position of the first downlink time unit #i.

Optionally, the first time information includes the UTC time corresponding to the first uplink time unit #j, which indicates that the first time information includes the UTC time corresponding to the start position of the first uplink time unit #j, or the first time information includes the UTC time corresponding to the end position of the first uplink time unit #j.

In some embodiments, the terminal device reporting the first measurement information based on the first configuration information includes: reporting the first measurement information to the network device based on the first configuration information; and/or reporting the first measurement information to the LMF based on the first configuration information. Optionally, in the case that the first configuration information is configured by the network device, the terminal device reports the first measurement information to the network device based on the first configuration information; and in the case that the first configuration information is configured by the LMF, the terminal device reports the first measurement information to the LMF based on the first configuration information. However, it is not excluded that in some embodiments, the first configuration information is configured by the network device, and the terminal device reports the first measurement information to the LMF based on the first configuration information; or the first configuration information is configured by the LMF, and the terminal device reports the first measurement information to the network device based on the first configuration information, which is not limited in the embodiments of the present disclosure.

In summary, in the method according to the embodiments of the present disclosure, the terminal device is positioned by the M downlink positioning signal resources and/or N uplink positioning signal resources, the M downlink positioning signal resources have a one-to-one correspondence relationship with the serving satellite positions of M instants, and the N uplink positioning signal resources have a one-to-one correspondence relationship with the serving satellite position of N instants, such that the positioning of the terminal device in the NTN system is achieved.

### Downlink Positioning Signal Resource Group

In some embodiments, the M downlink positioning signal resources are downlink positioning signal resources in a first downlink positioning signal resource group of the P downlink positioning signal resource groups, wherein P is a positive integer. Exemplarily, the first configuration information is used for determining the P downlink positioning signal resource groups, the P downlink positioning signal resource groups correspond to the P virtual TRP groups. The P downlink positioning signal resource groups include the first downlink positioning signal resource group, and the first downlink positioning signal resource group includes M downlink positioning signal resources.

In some embodiments, the downlink positioning signal resources in the first downlink positioning signal resource group or the downlink positioning signal resources in each of the P downlink positioning signal resource groups satisfy at least one of the following conditions.

A receive timing error in receiving a downlink positioning signal corresponding to a downlink positioning signal resource in the same downlink positioning signal resource group is within a first error range.

Exemplarily, the receive timing error within the first error range is understood as “the Rx timing error difference within a certain margin”. The receive timing error of the downlink positioning signal corresponds to the terminal device.

For example, the receive timing error of the downlink positioning signal corresponding to the downlink positioning signal resource in the same downlink positioning signal resource group corresponding to the terminal device is within a certain error range.

The transmit timing error in transmitting a downlink positioning signal corresponding to a downlink positioning signal resource in the same downlink positioning signal resource group is within a second error range.

Exemplarily, the transmit timing error within the second error margin is understood as “the Tx timing error difference within a certain margin”. The transmit timing error of the downlink positioning signal corresponds to the network device, serving satellite or reference point side.

For example, the downlink positioning signal transmit timing error corresponding to the downlink positioning signal resource in the same downlink positioning signal resource group corresponding to the network device or the serving satellite or the reference point is within a certain error range.

The first error range and/or second error range is a specific error range. Alternatively, the first error range and/or second error range is sufficiently small, or a range of the first error range and/or second error range is less than a threshold, or the first error range and/or second error range is negligible.

### Uplink Positioning Signal Resource Group

In some embodiments, the N uplink positioning signal resources are uplink positioning signal resources in the first uplink positioning signal resource group of the Q uplink positioning signal resource groups, wherein Q is a positive integer. Exemplarily, the first configuration information is used for determining the Q uplink positioning signal resource groups, and the Q uplink positioning signal resource groups correspond to Q virtual TRP groups. The Q uplink positioning signal resource groups include a first uplink positioning signal resource group, and the first uplink positioning signal resource group includes N uplink positioning signal resources.

In some embodiments, the uplink positioning signal resources in the first uplink positioning signal resource group or the uplink positioning signal resources in each of the Q uplink positioning signal resource groups satisfy at least one of the following conditions.

A transmit timing error in transmitting an uplink positioning signal corresponding to an uplink positioning signal resource in the same uplink positioning signal resource group is within a third error range.

Exemplarily, the transmit timing error within the third error range is understood as “the Tx timing error difference within a certain margin”. The transmit timing error of the uplink positioning signal corresponds to the terminal device.

For example, the transmit timing error of the uplink positioning signal corresponding to the uplink positioning signal resource in the same uplink positioning signal resource group corresponding to the terminal device is within a certain error range.

A receive timing error in receiving the uplink positioning signals corresponding to an uplink positioning signal resource in the uplink positioning signal resource group is within a fourth error range.

Exemplarily, the receive timing error within the fourth error range may be understood as “the Rx timing error difference within a certain margin”. The receive timing error of the uplink positioning signal corresponds to the network device, serving satellite or reference point side.

For example, the receive timing error of the uplink positioning signal corresponding to the uplink positioning signal resource in the same uplink positioning signal resource group corresponding to the network device, serving satellite or reference point is within a certain error range.

The third error range and/or the fourth error range is a specific error range. Alternatively, the third error range and/or the fourth error range is sufficiently small, or a range of the third error range and/or the fourth error range is less than a threshold, or the third error range and/or the fourth error range is negligible.

### Positioning Signal Resource (with Uplink and Downlink) Group

In some embodiments, the M downlink positioning signal resources and the N uplink positioning signal resources are positioning signal resources in a first positioning signal resource group of the R positioning signal resource groups, wherein R is a positive integer. Exemplarily, the first configuration information is used for determining R positioning signal resource groups, and the R positioning signal resource groups correspond to R virtual TRPs. The first positioning signal resource group of the R positioning signal resource groups includes M downlink positioning signal resources and N uplink positioning signal resources.

In some embodiments the positioning signal resources in the first positioning signal resource group or the positioning signal resources in each of the R positioning signal resource groups satisfy at least one of: a receive timing error in receiving a downlink positioning signal corresponding to a downlink positioning signal resource in a same positioning signal resource group being within a first error range; a transmit timing error in transmitting a downlink positioning signal corresponding to a downlink positioning signal resource in a same positioning signal resource group being within a second error range; a transmit timing error in transmitting an uplink positioning signal corresponding to an uplink positioning signal resource in a same positioning signal resource group being within a third error range; a receive timing error in receiving an uplink positioning signal corresponding to an uplink positioning signal resource in a same positioning signal resource group being within a fourth error range; an error of a sum of a receive timing error in receiving a downlink positioning signal corresponding to a downlink positioning signal resource in a same positioning signal resource group and a transmit timing error in transmitting an uplink positioning signal corresponding to an uplink positioning signal resource in a same positioning signal resource group being within a fifth error range; or an error of a sum of a transmit timing error in transmitting a downlink positioning signal corresponding to a downlink positioning signal resource in a same positioning signal resource group and a receive timing error in receiving an uplink positioning signal corresponding to an uplink positioning signal resource in a same positioning signal resource group being within a sixth error range.

Exemplarily, the error of the sum of the above errors within the fifth error range or the sixth error range is understood as “the ‘Rx timing errors+Tx timing errors’ difference within a certain margin”.

For example, the error of the sum of the receive timing error of the downlink positioning signal corresponding to the downlink positioning signal resource in the same positioning signal resource group corresponding to the terminal device and the transmit timing error of the uplink positioning signal corresponding to the uplink positioning signal resource in the same positioning signal resource group corresponding to the terminal device is within a certain error range.

For example, the error of the sum of the transmit timing error of the downlink positioning signal corresponding to the downlink positioning signal resource in the same positioning signal resource group corresponding to the network device, serving satellite or reference point and the receive timing error of an uplink positioning signal corresponding to the uplink positioning signal in the same positioning signal resource group corresponding to the network device, serving satellite or reference point is within a specific error range.

In some embodiments, the downlink positioning signal resources include downlink PRS resources. In some embodiments, the uplink positioning signal resource includes an uplink positioning SRS resource and/or an uplink multiple-input multiple-output (MIMO) SRS resource.

It should be noted that in the NTN systems, because the serving satellite positions at different instants are equated to TRPs or virtual TRPs, and the terminal device is able to acquire synchronization information between they and the serving satellites, in some cases (e.g., only one serving satellite is present), channels or signals (e.g., downlink channels or signals and/or uplink channels or signals) in addition to positioning signal resources are used to implement the positioning function as well.

In some embodiments, the downlink positioning signal resource includes at least one of: a downlink PRS resource, a synchronization signal block (SSB) resource, a channel state information reference signal (CSI-RS) resource, or a demodulation reference signal (DMRS) resource. Optionally, the DMRS resource includes a DMRS resource corresponding to a physical downlink shared channel (PDSCH) and/or a DMRS resource corresponding to a physical downlink control channel (PDCCH).

For example, the M downlink positioning signal resources include downlink PRS resources and CSI-RS resources.

As another example, the P downlink positioning signal resource groups include at least two downlink positioning signal resource groups, wherein the downlink positioning signal resource in one of the downlink positioning signal resource groups is an SSB resource, and the downlink positioning signal resource in the other of downlink positioning signal resource groups is a CSI-RS resource.

In some embodiments, the uplink positioning signal resource includes at least one of: a positioning SRS resource, a MIMO SRS resource, a physical random access channel (PRACH) resource, a DMRS resource. Optionally, the DMRS resource includes a DMRS resource corresponding to a physical uplink shared channel (PUSCH) and/or a DMRS resource corresponding to a physical uplink control channel (PUCCH).

For example, the N uplink positioning signal resources include positioning SRS resources and PRACH resources.

As another example, the Q uplink positioning signal resource groups include at least two uplink positioning signal resource groups, wherein the uplink positioning signal resource in one of the uplink positioning signal resource groups is an SRS resource, and the uplink positioning signal resource in the other of uplink positioning signal resource groups is a PRACH resource.

In some embodiments, the above M and N are equal. In some embodiments, the above P and Q are equal.

The fifth error range and/or the sixth error range is a particular error range. Alternatively, the fifth error range and/or the sixth error range is sufficiently small, or a range width of the fifth error range and/or the sixth error range is less than a threshold, or the fifth error range and/or the sixth error range is negligible.

In some embodiments, at least one of the first error range, the second error range, the third error range, the fourth error range, the fifth error range, or the sixth error range is default, or configured, or predefined.

FIG. 12 illustrates a flowchart of a wireless communication method for positioning according to some embodiments of the present disclosure. The embodiment is illustrated by an example where the method is performed by a network device or a serving satellite. The method includes the following processes.

In 202, first configuration information is acquired.

The first configuration information is used for determining (or configuring) M downlink positioning signal resources and/or N uplink positioning signal resources, wherein M and N are positive integers. The first configuration information is one or more pieces of configuration information.

In the case that the execution subject is the network device (indicating an access network device in the embodiment), the network device acquiring the first configuration information includes: the network device determining or generating the first configuration information, and/or the network device receiving the first configuration information transmitted by the LMF. That is, the first configuration information is configured by the network device and/or the LMF. In the case that the first configuration information is one piece of information, the first configuration information is generated or determined by the network device or configured by the LMF. In the case that the first configuration information is more than one pieces of information, the first configuration information is determined, generated or configured collaboratively by the network device and the LMF.

In the case that the execution subject is a serving satellite, the serving satellite acquiring the first configuration information includes: the serving satellite receiving the first configuration information transmitted by the network device, and/or the serving satellite receiving the first configuration information transmitted by the LMF. That is, the first configuration information is configured by the network device and/or the LMF. In the case that the first configuration information is one piece of information, the first configuration information is configured by the network device or configured by the LMF. In the case that the first configuration information is more than one pieces of information, the first configuration information is configured collaboratively by the network device and the LMF.

In some embodiments, the one piece of first configuration information is configured to simultaneously determine the M downlink positioning signal resources and the N uplink positioning signal resources. In some embodiments, the first configuration information is at least two pieces of information, wherein one of the two pieces of first configuration information is configured determine the M downlink positioning signal resources, and the other of the two pieces of first configuration information is used for determining the N uplink positioning signal resources.

In some embodiments, the M downlink positioning signal resources have a one-to-one correspondence relationship with serving satellite positions of M instants, or the M downlink positioning signal resources have a one-to-one correspondence relationship with M virtual TRPs. In some embodiments, the N uplink positioning signal resources have a one-to-one correspondence relationship with the serving satellite positions of N instants, or the N uplink positioning signal resources have a one-to-one correspondence relationship with the N virtual TRPs. The M instants are different instants in the case that M is an integer greater than 1, and the N instants are different instants in the case that N is an integer greater than 1.

In some embodiments, the one or more first configuration information is used for determining P downlink positioning signal resource groups, and/or Q uplink positioning signal resource groups. Each downlink positioning signal resource group of the P downlink positioning signal resource groups corresponds to a virtual TRP group, and each uplink positioning signal resource group of the Q uplink positioning signal resource groups corresponds to a virtual TRP group. The first downlink positioning signal resource group of the P downlink positioning signal resource groups includes M downlink positioning signal resources, and the first uplink positioning signal resource group of the Q uplink positioning signal resource groups includes N uplink positioning signal resources.

In some embodiments, the one or more pieces of first configuration information is used for determining R positioning signal resource groups. Each of the R positioning signal resource groups corresponds to a virtual TRP group. The first positioning signal resource group of the R positioning signal resource groups includes M downlink positioning signal resources and N uplink positioning signal resources.

In some embodiments, the network device or the serving satellite transmits at least one downlink positioning signal of the M downlink positioning signals based on the M downlink positioning signal resources; and/or receives at least one uplink positioning signal of the N uplink positioning signals based on the N uplink positioning signal resources. In some embodiments, the network device or the serving satellite transmitting the at least one downlink positioning signal of the M downlink positioning signals based on the M downlink positioning signal resources includes: transmitting the M downlink positioning signals based on the M downlink positioning signal resources. In some embodiments, the network device or serving satellite receiving the at least one uplink positioning signal of the N uplink positioning signals based on the N uplink positioning signal resources includes: receiving the N uplink positioning signals based on the N uplink positioning signal resources.

In 204, second measurement information is reported based on the first configuration information, wherein the second measurement information includes at least one of a second time difference or second time information.

The second measurement information includes related measurement information configured to implement multi-RTT positioning, serving satellite position positioning corresponding to a plurality of instants, or multi-TRP positioning. The second measurement information is related to a receive timing of the uplink positioning signal and/or a transmit timing of the downlink positioning signal.

In some embodiments, the second measurement information is configured to calculate a distance or RTT between the terminal device and the virtual TRP.

In some embodiments, the above method further includes: the network device or the serving satellite transmitting at least one downlink positioning signal of the M downlink positioning signals based on the M downlink positioning signal resources; and/or receiving at least one uplink positioning signal of the N uplink positioning signals based on the N uplink positioning signal resources.

In some embodiments, transmitting the at least one downlink positioning signal of the M downlink positioning signals based on the M downlink positioning signal resources includes: transmitting the M downlink positioning signals based on the M downlink positioning signal resources. In some embodiments, receiving the at least one uplink positioning signal of the N uplink positioning signals based on the N uplink positioning signal resources includes: receiving the N uplink positioning signals based on the N uplink positioning signal resources,

In some embodiments, the second time difference is determined based on a receive timing of the at least one group of uplink positioning signals and a transmit timing of the downlink positioning signals. For example, the second time difference is a difference between the receive timing of the uplink positioning signal and the transmit timing of the downlink positioning signal. Optionally, the second time difference is a positive or negative number or 0.

In some embodiments, the network device reports the second measurement information to the LMF based on the first configuration information, such that the LMF performs multi-RTT positioning for the terminal device based on the first measurement information and the second measurement information.

In some embodiments, the network device described above also positions itself. The network device receives the first measurement information reported by the terminal device, and the network device performs multi-RTT positioning for the terminal device based on the first measurement information and the second measurement information. Optionally, the network device also reports the result of positioning the terminal device to the LMF or notifies the terminal device.

### Second Time Difference

The second time difference is a difference between a receive timing of the uplink positioning signal and a transmit timing of the downlink positioning signal. For example, the second time difference is a gNB Rx-Tx time difference or a serving satellite Rx-Tx time difference. Optionally, the second time difference is positive or negative number or 0.

In some embodiments, the unit of the second time difference is a slot, a subframe or a millisecond or a microsecond or a sampling interval unit Tc, and the like, which is not limited in the present disclosure.

### Second Downlink Time Unit

In some embodiments, the transmit timing of the downlink positioning signal is a transmit timing of the second downlink time unit, or the transmit timing of the downlink positioning signal is a UTC time corresponding to the transmit timing of the second downlink time unit.

The second downlink time unit includes at least one time unit corresponding to at least one of the M downlink positioning signal resources.

In some embodiments, the second downlink time unit includes at least one of: a time unit corresponding to a first downlink positioning signal resource of the M downlink positioning signal resources; a time unit corresponding to a last downlink positioning signal resource of the M downlink positioning signal resources; or a time unit of the M downlink positioning signal resources configured to determine the transmit timing of the downlink positioning signal. By way of example but not limitation, the second downlink time unit is a time unit determined by the network device or the serving satellite itself.

### Second Uplink Time Unit

In some embodiments, the receive timing of the uplink positioning signal is a receive timing of the second uplink time unit, or the receive timing of the uplink positioning signal is a UTC time corresponding to the receive timing of the second uplink time unit.

The second uplink time unit includes at least one time unit corresponding to at least one uplink positioning signal resource of the N uplink positioning signal resources.

In some embodiments, the second uplink time unit includes at least one of: a time unit corresponding to a first uplink positioning signal resource of the N uplink positioning signal resources; a time unit corresponding to a last uplink positioning signal resource of the N uplink positioning signal resources; or a time unit of the N uplink positioning signal resources configured to determine a receive timing of the uplink positioning signal.

By way of example but not limitation, the second uplink time unit is a time unit determined by the network device or the serving satellite.

In some embodiments, the time unit is at least one of a subframe, a slot, a frame, a symbol group, or a symbol.

In some embodiments, the second time difference is defined as T_{gNB-RX}-T_{gNB-RX}. Alternatively, the second time difference is defined as a time difference between the receive timing of the network device receiving the second uplink time unit #k and the transmit timing of the network device transmitting the second downlink time unit #1.

Optionally, T_{gNB-RX} is the receive timing of the network device receiving the second uplink time unit #k, or T_{gNB-RX} is the UTC time corresponding to the receive timing of the network device receiving the second uplink time unit #k. Optionally, the receive timing is determined based on a first arrival path of the received signal. Optionally, the receive timing (e.g., the first arrival path corresponding to the start position of this second uplink time unit #k) is determined based on one or more uplink positioning signal resources such as uplink SRS resources. Optionally, the second uplink time unit #k is a second uplink time unit including an uplink positioning signal and associated with the terminal device, or the second uplink time unit #k includes at least one time unit corresponding to the N uplink positioning signal resources. For example, the second uplink time unit #k includes a time unit in which the first uplink positioning signal resource of the N uplink positioning signal resources is located. For example, the second uplink time unit #k includes a time unit in which a last uplink positioning signal resource of the N uplink positioning signal resources is located. As another example, the second uplink time unit #k is determined by the network device from the time units in which the N uplink positioning signal resources are located.

Optionally, T_{gNB-RX} represents a transmit timing of the network device transmitting the second downlink time unit #1. Alternatively, T_{gNB-RX} represents a UTC time corresponding to the transmit timing of the network device transmitting the second downlink time unit #1. Optionally, the second downlink time unit #1 includes at least one time unit corresponding to the M downlink positioning signal resources. For example, the second downlink time unit #1 includes a time unit in which the first downlink positioning signal resource of the M downlink positioning signal resources is located. As another example, the second downlink time unit #1 includes the time unit in which the last downlink positioning signal resource of the M downlink positioning signal resources is located. As another example, the second downlink time unit #1 is determined by the network device from the time units in which the M downlink positioning signal resources are located.

In some embodiments, it is also considered that the second time difference, e.g., the gNB Rx-Tx time difference, is acquired based on the signal actual receive time unit timing and the signal actual transmission time unit timing.

### Second Time Information

In some embodiments, the second time information includes at least one of: a second downstream time unit; a second uplink time unit; a UTC time corresponding to the second downlink time unit; or a UTC time corresponding to the second uplink time unit.

The second downlink time unit is configured to determine a transmit timing of the downlink positioning signal, and the second uplink time unit is configured to determine a receive timing of the uplink positioning signal.

In some embodiments, the second downlink time unit is determined based on at least one of a downlink timing of the serving satellite, a downlink timing of the reference point, or a downlink timing of the network device. In some embodiments, the second uplink time unit is determined based on at least one of an uplink timing of the serving satellite, an uplink timing of the reference point, or an uplink timing of the network device.

In some embodiments, the network device reporting the second measurement information based on the first configuration information includes: reporting the second measurement information to the LMF based on the first configuration information. In some embodiments, the serving satellite reporting the second measurement information based on the first configuration information includes: reporting the second measurement information to the network device or the LMF based on the first configuration information.

In some embodiments, the second time information includes at least one of a second downlink time unit #1, a second uplink time unit #k, a UTC time corresponding to the second downlink time unit #1, or a UTC time corresponding to the second uplink time unit #k.

Optionally, the second time information includes the second downlink time unit #1, which indicates that the second time information includes start position information of the second downlink time unit #1, or the second time information includes end position information of the second downlink time unit #1.

Optionally, the second time information includes a second uplink time unit #k, which indicates that the second time information includes start position information of the second uplink time unit #k, or the second time information includes end position information of the second uplink time unit #k.

Optionally, the second time information includes the UTC time corresponding to the second downlink time unit #1, which indicates that the second time information includes the UTC time corresponding to the start position of the second downlink time unit #1, or the second time information includes the UTC time corresponding to the end position of the second downlink time unit #1.

Optionally, the second time information includes the UTC time corresponding to the second uplink time unit #k, which indicates that the second time information includes the UTC time corresponding to the start position of the second uplink time unit #k, or the second time information includes the UTC time corresponding to the end position of the second uplink time unit #k.

In some embodiments, the second downlink time unit #1 is determined based on one of: a downlink timing of the serving satellite, a downlink timing of the reference point, or a downlink timing of the network device.

In some embodiments, the second uplink time unit #k is determined based on one of: an uplink timing of the serving satellite, an uplink timing of the reference point, or an uplink timing of the network device.

In summary, in the method according to the embodiments of the present disclosure, the terminal device is positioned by the M downlink positioning signal resources and/or N uplink positioning signal resources, the M downlink positioning signal resources have a one-to-one correspondence relationship with the serving satellite positions of M instants, and the N uplink positioning signal resources have a one-to-one correspondence relationship with the serving satellite position of N instants, such that the positioning of the terminal device in the NTN system is achieved.

### Downlink Positioning Signal Resource Group

In some embodiments, the M downlink positioning signal resources are downlink positioning signal resources in the first downlink positioning signal resource group of the P downlink positioning signal resource groups, wherein P is a positive integer. Exemplarily, the first configuration information is used for determining P downlink positioning signal resource groups, and the P downlink positioning signal resource groups correspond to the P virtual TRP groups. The P downlink positioning signal resource groups include a first downlink positioning signal resource group, and the first downlink positioning signal resource group includes M downlink positioning signal resources.

In some embodiments, the downlink positioning signal resources in the first downlink positioning signal resource group or the downlink positioning signal resources in each of the P downlink positioning signal resource groups satisfy at least one of the following conditions.

The receive timing error in receiving a downlink positioning signal corresponding to a downlink positioning signal resource in the same downlink positioning signal resource group is within a first error range.

Exemplarily, the receive timing error within the first error range is understood as “the Rx timing error difference within a certain margin”. The receive timing error of the downlink positioning signal corresponds to the terminal device.

For example, the receive timing error of the downlink positioning signal corresponding to the downlink positioning signal resource in the same downlink positioning signal resource group corresponding to the terminal device is within a certain error range.

The transmit timing error in transmitting a downlink positioning signal corresponding to a downlink positioning signal resource in the same downlink positioning signal resource group is within a second error range.

Exemplarily, the transmit timing error within the second error margin is understood as “the Tx timing error difference within a certain margin”. The transmit timing error of the downlink positioning signal corresponds to the network device, serving satellite or reference point side.

For example, the downlink positioning signal transmit timing error corresponding to the downlink positioning signal resource in the same downlink positioning signal resource group corresponding to the network device or the serving satellite or the reference point is within a certain error range.

The first error range and/or second error range is a specific error range. Alternatively, the first error range and/or second error range is sufficiently small, or a range of the first error range and/or second error range is less than a threshold, or the first error range and/or second error range is negligible.

### Uplink Positioning Signal Resource Group

In some embodiments, the N uplink positioning signal resources are uplink positioning signal resources in the first uplink positioning signal resource group of the Q uplink positioning signal resource groups, wherein Q is a positive integer. Exemplarily, the first configuration information is used for determining the Q uplink positioning signal resource groups, and the Q uplink positioning signal resource groups correspond to Q virtual TRP groups. The Q uplink positioning signal resource groups include a first uplink positioning signal resource group, and the first uplink positioning signal resource group includes N uplink positioning signal resources.

In some embodiments, the uplink positioning signal resources in the first uplink positioning signal resource group or the uplink positioning signal resources in each of the Q uplink positioning signal resource groups satisfy at least one of the following conditions.

A transmit timing error in transmitting an uplink positioning signal corresponding to an uplink positioning signal resource in the same uplink positioning signal resource group is within a third error range.

Exemplarily, the transmit timing error within the third error range is understood as “the Tx timing error difference within a certain margin”. The transmit timing error of the uplink positioning signal corresponds to the terminal device.

For example, the transmit timing error of the uplink positioning signal corresponding to the uplink positioning signal resource in the same uplink positioning signal resource group corresponding to the terminal device is within a certain error range.

A receive timing error in receiving the uplink positioning signals corresponding to an uplink positioning signal resource in the uplink positioning signal resource group is within a fourth error range.

Exemplarily, the receive timing error within the fourth error range may be understood as “the Rx timing error difference within a certain margin”. The receive timing error of the uplink positioning signal corresponds to the network device, serving satellite or reference point side.

For example, the receive timing error of the uplink positioning signal corresponding to the uplink positioning signal resource in the same uplink positioning signal resource group corresponding to the network device, serving satellite or reference point is within a certain error range.

The third error range and/or the fourth error range is a specific error range. Alternatively, the third error range and/or the fourth error range is sufficiently small, or a range of the third error range and/or the fourth error range is less than a threshold, or the third error range and/or the fourth error range is negligible.

### Positioning Signal Resource (with Uplink and Downlink) Group

In some embodiments, the M downlink positioning signal resources and the N uplink positioning signal resources are positioning signal resources in a first positioning signal resource group of the R positioning signal resource groups, wherein R is a positive integer. Exemplarily, the first configuration information is used for determining R positioning signal resource groups, and the R positioning signal resource groups correspond to R virtual TRPs. The first positioning signal resource group of the R positioning signal resource groups includes M downlink positioning signal resources and N uplink positioning signal resources.

In some embodiments the positioning signal resources in the first positioning signal resource group or the positioning signal resources in each of the R positioning signal resource groups satisfy at least one of: a receive timing error in receiving a downlink positioning signal corresponding to a downlink positioning signal resource in a same positioning signal resource group being within a first error range; a transmit timing error in transmitting a downlink positioning signal corresponding to a downlink positioning signal resource in a same positioning signal resource group being within a second error range; a transmit timing error in transmitting an uplink positioning signal corresponding to an uplink positioning signal resource in a same positioning signal resource group being within a third error range; a receive timing error in receiving an uplink positioning signal corresponding to an uplink positioning signal resource in a same positioning signal resource group being within a fourth error range; an error of a sum of a receive timing error in receiving a downlink positioning signal corresponding to a downlink positioning signal resource in a same positioning signal resource group and a transmit timing error in transmitting an uplink positioning signal corresponding to an uplink positioning signal resource in a same positioning signal resource group being within a fifth error range; or an error of a sum of a transmit timing error in transmitting a downlink positioning signal corresponding to a downlink positioning signal resource in a same positioning signal resource group and a receive timing error in receiving an uplink positioning signal corresponding to an uplink positioning signal resource in a same positioning signal resource group being within a sixth error range.

Exemplarily, the error of the sum of the above errors within the fifth error range or the sixth error range is understood as “the ‘Rx timing errors+Tx timing errors’ difference within a certain margin”.

For example, the error of the sum of the receive timing error of the downlink positioning signal corresponding to the downlink positioning signal resource in the same positioning signal resource group corresponding to the terminal device and the transmit timing error of the uplink positioning signal corresponding to the uplink positioning signal resource in the same positioning signal resource group corresponding to the terminal device is within a certain error range.

For example, the error of the sum of the transmit timing error of the downlink positioning signal corresponding to the downlink positioning signal resource in the same positioning signal resource group corresponding to the network device, serving satellite or reference point and the receive timing error of an uplink positioning signal corresponding to the uplink positioning signal in the same positioning signal resource group corresponding to the network device, serving satellite or reference point is within a specific error range.

In some embodiments, the downlink positioning signal resources include downlink PRS resources. In some embodiments, the uplink positioning signal resource includes an uplink positioning SRS resource and/or an uplink MIMO SRS resource.

In some embodiments, the downlink positioning signal resource includes at least one of: a downlink PRS resource, an SSB resource, a CSI-RS resource, or a DMRS resource. Optionally, the DMRS resource includes a DMRS resource corresponding to a PDSCH and/or a DMRS resource corresponding to a PDCCH.

In some embodiments, the uplink positioning signal resource includes at least one of: a positioning SRS resource, a MIMO SRS resource, a PRACH resource, or a DMRS resource. Optionally, the DMRS resource includes a DMRS resource corresponding to a PUSCH and/or a DMRS resource corresponding to a PUCCH.

In some embodiments, the above M and N are equal. In some embodiments, the above P and Q are equal.

In some embodiments, at least one of the first error range, the second error range, the third error range, the fourth error range, the fifth error range, or the sixth error range is default, or configured, or predefined.

### Embodiment 1

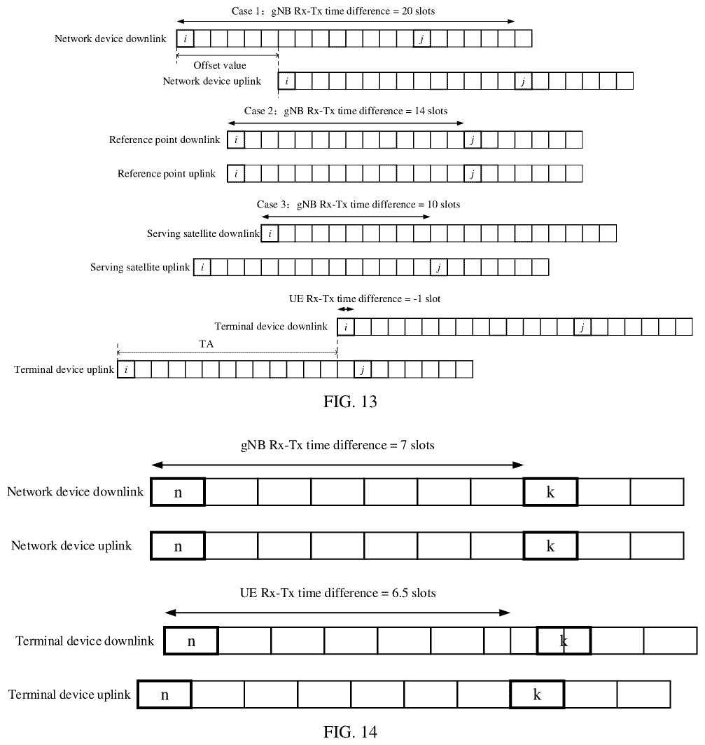

FIG. 13 illustrates an example of a virtual TRP and terminal device reporting the measurement information by employing the multi-RTT method in the NTN scenario. As shown in FIG. 13, the network device or the virtual TRP transmits a PRS signal on downlink slot #i, and the PRS signal is received by the terminal device on downlink slot #i. The terminal device is configured to transmit an SRS signal for positioning on uplink slot #j, and the SRS signal is received by the network device or the virtual TRP on uplink slot #j.

The first time difference (UE Rx-Tx time difference) is defined as a time difference between the UTC time corresponding to the receive timing of the downlink time unit #i received by the terminal device and the UTC time corresponding to the transmit timing of the uplink time unit #j transmitted by the terminal device.

In the embodiment, T_{UE-RX}−T_{UE-TX}=T_{UE DL slot i}−T_{UE UL slot j}=−1 Slot.

The second time difference (gNB Rx-Tx time difference) is defined as a time difference between the UTC time corresponding to the receive timing of the uplink time unit #j received by the network device and the UTC time corresponding to the transmit timing of the downlink time unit #i transmitted by the network device.

In the embodiment, in the case that the uplink time unit #j and the downlink time unit #i are determined based on the uplink timing and the downlink timing on the network device respectively (case 1 in FIG. 13),

$${T}_{gNB - RX} - {T}_{gNB - TX} = {T}_{gNB UL slot j} - {T}_{gNB DL slot i} = 20 slots .$$

In the case that the uplink time cell #j and the downlink time cell #i are determined based on the uplink timing and downlink timing on the reference point side respectively (case 2 in FIG. 13),

$${T}_{gNB - RX} - {T}_{gNB - TX} = {T}_{gNB UL slot j} - {T}_{gNB DL slot i} = 14 slots .$$

In the case that the uplink time cell #j and the downlink time cell #i are determined based on the satellite-side uplink timing and downlink timing respectively (case 3 in FIG. 13),

$${T}_{gNB - RX} - {T}_{gNB - TX} = {T}_{gNB UL slot j} - {T}_{gNB DL slot i} = 10 slots .$$

It should be understood that in this example, the unit of slots is only used for presentation convenience. In the embodiments of the present disclosure, the unit of the actual determined or reported time difference is a slot, a subframe, a millisecond, a microsecond, a sampling interval unit Tc, or the like, which is not limited in the present disclosure.

Therefore, the UE Rx-Tx time difference reported by the terminal device to the LMF is −1 slot, and the gNB Rx-Tx time difference reported by the network device to the LMF includes at least one of: the gNB Rx-Tx time difference corresponding to the timing of the network device is 20 slots, the gNB Rx-Tx time difference corresponding to the timing of the reference point is 14 slots, and the gNB corresponding to the timing of the satellite is 10 slots. Correspondingly, the LMF acquires that the RTT between the terminal device and the network device is 19 slots based on the sum of the UE Rx-Tx time difference reported by the terminal device (−1 slot) and the gNB Rx-Tx time difference reported by the network device corresponding to the timing of the network device (20 slots); and/or the LMF acquires that the RTT between the terminal device and the reference point is 13 slots based on the sum of the UE Rx-Tx time difference reported by the terminal device (−1 slot) and the gNB Rx-Tx time difference reported by the network device corresponding to the timing of the reference point (14 slots); and/or the LMF acquires that the RTT between the terminal device and the satellite is 9 slots based on the sum of the UE Rx-Tx time difference reported by the terminal device (−1 slot) and the gNB Rx-Tx time difference reported by the network device corresponding to the timing of the satellite (10 slots).

In the same way, the LMF acquires the RTT between the terminal device and the serving satellite at other times (i.e., virtual TRPs), and then acquires the position information of the terminal device by performing solution using the position information of each TRP.

### Embodiment 2

It should be noted that the enhanced definition of the UE Rx-Tx time difference and the definition of the gNB Rx-Tx time difference are also applicable to the TN network scenario. FIG. 14 illustrates an example of reporting measurements of the TRP and terminal device by using the multi-RTT method in the TN scenario. As shown in FIG. 14, the network device transmits a PRS signal on a downlink slot #i, and the PRS signal is received by the terminal device on the downlink slot #i. The terminal device is configured to transmit the SRS signal for positioning on an uplink slot #j, and the SRS signal is received by the network device on the uplink slot #j.

The first time difference (UE Rx-Tx time difference) is defined as a time difference between the UTC time corresponding to the receive timing of the downlink time unit #i received by the terminal device and the UTC time corresponding to the transmit timing of the uplink time unit #j transmitted by the terminal device.

In the embodiment, T_{UE-RX}−T_{UE-TX}=T_{UE DL slot i}−T_{UE UL slot j}=−6.5 slots.

The second time difference (gNB Rx-Tx time difference) is defined as the time difference between the UTC time corresponding to the receive timing of the uplink time unit #j received by the network device and the UTC time corresponding to the transmit timing of the downlink time unit #i transmitted by the network device.

In the embodiment, T_{gNB-RX}−T_{gNB-RX}=T_{gNB UL slot j}−T_{gNB DL slot i}=7 slots.

It is also understood that in the example, the unit of slots is only used for convenience of presentation and the unit of time difference is not limited to be slots.

Therefore, the terminal device reports to the LMF that the UE Rx-Tx time difference corresponding to the TRP is −6.5 slots, and the network device reports to the LMF that the gNB Rx-Tx time difference corresponding to the TRP is 7 slots. The LMF acquires that the RTT between the terminal device and the TRP is 0.5 slot based on the sum of the UE Rx-Tx time difference (−6.5 slots) reported by the terminal device and the gNB Rx-Tx time difference (7 slots) corresponding to the TRP reported by the network device.

### Embodiment 3

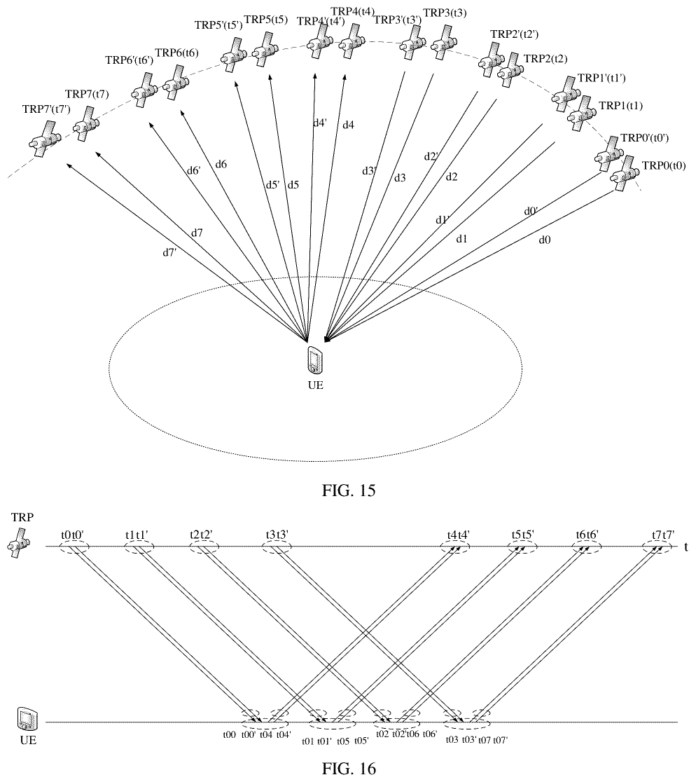

FIG. 15 illustrates a schematic diagram of the positioning scenario corresponding to the TRP group (or virtual TRP group) in the NTN scenario. As shown in FIG. 15, the terminal device is configured with 8 TRP groups, wherein the TRP group i includes a TRP i corresponding to the serving satellite position at an instant ti and a TRP i′ corresponding to the serving satellite position at an instant ti′, and the distance between the TRP i and the terminal device is di, and the distance between the TRP i′ and the terminal device is di′, wherein i=0, 1, 2, 3, 4, 5, 6, 7. In the embodiment, TRP groups 0, 1, 2, and 3 are TRP groups corresponding to the downlink PRS reception, and TRP groups 4, 5, 6, and 7 are TRP groups corresponding to the uplink positioning SRS transmission.

FIG. 16 illustrates a schematic diagram of transmitting a signal corresponding to the positioning signal resource group (or TRP group or virtual TRP group) in the NTN scenario. In some embodiments, FIG. 16 is a schematic diagram of transmitting a signal in the scenario shown in FIG. 15.

In the embodiment, description is given by an example where the downlink positioning signal is a downlink PRS and the uplink positioning signal is an uplink SRS, which is not limited in the present disclosure.

In some optional embodiments, it is considered that: the receive timing error corresponding to the terminal device in receiving the downlink PRS corresponding to an instant t0 and an instant t0′ is sufficiently small (e.g., less than a threshold or negligible within a specific error range); the receive timing error corresponding to the terminal device in receiving the downlink PRS corresponding an instant t1 and an instant t1′ is sufficiently small; the receive timing error corresponding to the terminal device in receiving the downlink PRS corresponding to an instant t2 and an instant t2′ is sufficiently small; and the receive timing error corresponding to the terminal device in receiving the downlink PRS corresponding to an instant t3 and an instant t3′ is sufficiently small.

In some optional embodiments, it is considered that: the transmit timing error corresponding to the terminal device in transmitting the uplink SRS corresponding to an instant t4 and an instant t4′ is sufficiently small (e.g., less than a threshold or negligible within a specific error range); the transmit timing error corresponding to the terminal device is sufficiently small; the corresponding uplink SRS of the terminal device in transmitting the uplink SRS corresponding to an instant t5 and an instant t5′ is sufficiently small; the transmit timing error corresponding to the terminal device is sufficiently small; and the corresponding uplink SRS of the terminal device in transmitting the uplink SRS corresponding to an instant t6 and an instant t6′ is sufficiently small.

In some optional embodiments, it is considered that: the receive timing error corresponding to the terminal device in receiving downlink PRS corresponding to the instant t0 and the instant t0′ is sufficiently small, and transmit timing error corresponding to the terminal device in transmitting uplink SRS corresponding to instant t4 and instant t4′ is sufficiently small; the receive timing error corresponding to the terminal device in receiving downlink PRS corresponding to the instant t1 and the instant t1′ is sufficiently small, and transmit timing error corresponding to the terminal device in transmitting uplink SRS corresponding to the instant t5 and the instant t5′ is sufficiently small; the receive timing error corresponding to the terminal device in receiving downlink PRS corresponding to the instant t2 and the instant t2′ is sufficiently small, and transmit timing error corresponding to the terminal device in transmitting uplink SRS corresponding to the instant t6 and the instant t6′ is sufficiently small; and the receive timing error corresponding to the terminal device in receiving downlink PRS corresponding to the instant t3 and the instant t3′ is sufficiently small, and transmit timing error corresponding to the terminal device in transmitting uplink SRS corresponding to an instant t7 and an instant t7′ is sufficiently small.

In some optional embodiments, it is considered that: the transmit timing error corresponding to the network device in transmitting the downlink PRS corresponding to the instant t0 and instant t0′ is sufficiently small (e.g., less than a threshold or negligible within a specific error range); the transmit timing error corresponding to the network device in transmitting the downlink PRS corresponding to the instant t1 and instant t1′ is sufficiently small; the transmit timing error corresponding to the network device in transmitting the downlink PRS corresponding to the instant t2 and the instant t2′ is sufficiently small; and the transmit timing error corresponding to the network device in transmitting the downlink PRS corresponding to the instant t3 and the instant t3′ is sufficiently small.

In some optional embodiments, it is considered that: the receive timing error corresponding to the network device in receiving the uplink SRS corresponding to instant t4 and instant t4′ is sufficiently small (e.g., less than a threshold or negligible within a specific error range); the receive timing error corresponding to the network device in receiving the uplink SRS corresponding to the instant t5 and the instant t5′ is sufficiently small; the receive timing error corresponding to the network device in receiving the uplink SRS corresponding to instant t6 and instant t6′ is sufficiently small; and the receive timing error corresponding to the network device in receiving the uplink SRS corresponding to the instant t7 and the instant t7′ is sufficiently small.

In some optional embodiments, it is considered that: the transmit timing error corresponding to the network device in transmitting the downlink PRS corresponding to the instant t0 and the instant t0′ is sufficiently small, and the receive timing error corresponding to the network device in receiving the uplink SRS corresponding to the instant t4 and the instant t4′ is sufficiently small; the transmit timing error corresponding to the network device in transmitting the downlink PRS corresponding to the instant t1 and the instant t1′ is sufficiently small, and the receive timing error corresponding to the network device in receiving the uplink SRS corresponding to the instant t5 and the instant t5′ is sufficiently small; the transmit timing error corresponding to the network device in transmitting the downlink PRS corresponding to the instant t2 and the instant t2′ is sufficiently small, and the receive timing error corresponding to the network device in receiving the uplink SRS corresponding to the instant t6 and instant t6′ is sufficiently small; and the transmit timing error corresponding to the network device in transmitting the downlink PRS corresponding to the instant t3 and the instant t3′ is sufficiently small, and the receive timing error corresponding to the network device in receiving the uplink SRS corresponding to the instant t7 and the instant t7′ is sufficiently small.

In some optional embodiments, the first time difference reported by the terminal device includes at least one of t04-t00, t04′-t00′, t04-t00′, t04′-t00, t05-t01, t05′-t01′, t05-t01′, t05-t01, t06-t02, t06′-t02′, t06-t02′, t06′-t02, t07-t03, t07′-t03′, t07-t03′, or t07′-t03.

In some optional embodiments, the first time information reported by the terminal device includes at least one of t00, t00′, t01, t01′, t02, t02′, t03, t03′, t04, t04′, t05, t05′, t06, t06′, t07, or t07′.

In some optional embodiments, the second time difference reported by the network device includes at least one of t4-t0, t4′-t0′, t4-t0′, t4′-t0, t5-t1, t5′-t1′, t5-t1′, t5′-t1, t6-t2, t6′-t2′, t6-t2′, t6′-t2, t7-t3, t7′-t3′, t7-t3′, or t7′-t3.

In some optional embodiments, the second time information reported by the network device includes at least one of t0, t0′, t1, t1′, t2, t2′, t3, t3′, t4, t4′, t5, t5′, t6, t6′, t7, or t7′.

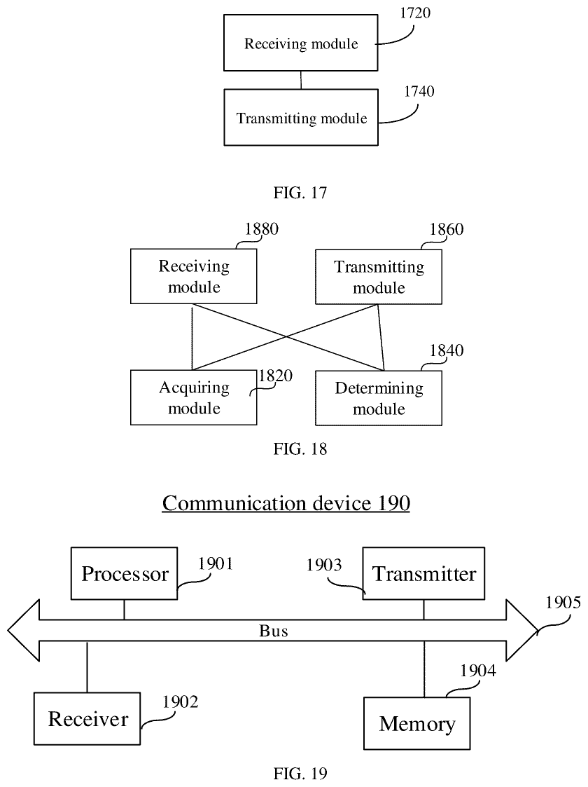

FIG. 17 illustrates a block diagram of a wireless communication apparatus for positioning according to some embodiments of the present disclosure. The apparatus is implemented as a terminal device or a portion of a terminal device by software, hardware or a combination of both. The apparatus includes: a receiving module 1720, configured to receive first configuration information, wherein the first configuration information is used for determining M downlink positioning signal resources, and/or N uplink positioning signal resources, wherein M and N are positive integers; and a transmitting module 1740, configured to report first measurement information based on the first configuration information, wherein the first measurement information includes at least one of a first time difference or first time information.

In some embodiments, the M downlink positioning signal resources are downlink positioning signal resources in a first downlink positioning signal resource group of P downlink positioning signal resource groups, wherein P is a positive integer.

In some embodiments, the downlink positioning signal resources in the first downlink positioning signal resource group or downlink positioning signal resources in each of the P downlink positioning signal resource groups satisfy at least one of: a receive timing error in receiving a downlink positioning signal corresponding to a downlink positioning signal resource in a same downlink positioning signal resource group being within a first error range; or a transmit timing error in transmitting a downlink positioning signal corresponding to a downlink positioning signal resource in a same downlink positioning signal resource group being within a second error range.

In some embodiments, the N uplink positioning signal resources are uplink positioning signal resources in a first uplink positioning signal resource group of Q uplink positioning signal resource groups, wherein Q is a positive integer.

In some embodiments, the uplink positioning signal resources in the first uplink positioning signal resource group or uplink positioning signal resources in each of the Q uplink positioning signal resource groups satisfy at least one of: a transmit timing error in transmitting an uplink positioning signal corresponding to an uplink positioning signal resource in a same uplink positioning signal resource group being within a third error range; or a receive timing error in receiving an uplink positioning signal corresponding to an uplink positioning signal resource in the uplink positioning signal resource group being within a fourth error range.

In some embodiments, the M downlink positioning signal resources and the N uplink positioning signal resources are positioning signal resources in a first positioning signal resource group of R positioning signal resource groups, wherein R is a positive integer.

In some embodiments, the positioning signal resources in the first positioning signal resource group or positioning signal resources in each of the R positioning signal resource groups satisfy at least one of: a receive timing error in receiving a downlink positioning signal corresponding to a downlink positioning signal resource in a same positioning signal resource group being within a first error range; a transmit timing error in transmitting a downlink positioning signal corresponding to a downlink positioning signal resource in a same positioning signal resource group being within a second error range; a transmit timing error in transmitting an uplink positioning signal corresponding to an uplink positioning signal resource in a same positioning signal resource group being within a third error range; a receive timing error in receiving an uplink positioning signal corresponding to an uplink positioning signal resource in a same positioning signal resource group being within a fourth error range; an error of a sum of a receive timing error in receiving a downlink positioning signal corresponding to a downlink positioning signal resource in a same positioning signal resource group and a transmit timing error in transmitting an uplink positioning signal corresponding to an uplink positioning signal resource in a same positioning signal resource group being within a fifth error range; or an error of a sum of a transmit timing error in transmitting a downlink positioning signal corresponding to a downlink positioning signal resource in a same positioning signal resource group and a receive timing error in receiving an uplink positioning signal corresponding to an uplink positioning signal resource in a same positioning signal resource group being within a sixth error range.

In some embodiments, the first time difference is a difference between a receive timing of a downlink positioning signal and a transmit timing of an uplink positioning signal.

In some embodiments, the receive timing of the downlink positioning signal is a receive timing of a first downlink time unit, or the receive timing of the downlink positioning signal is a universal time coordinated (UTC) time corresponding to the receive timing of the first downlink time unit; wherein the first downlink time unit includes at least one time unit corresponding to at least one of the M downlink positioning signal resources.

In some embodiments, the first downlink time unit includes at least one of: a time unit corresponding to a first downlink positioning signal resource of the M downlink positioning signal resources; a time unit corresponding to a last downlink positioning signal resource of the M downlink positioning signal resources; or a time unit of the M downlink positioning signal resources configured to determine the receive timing of the downlink positioning signal.

In some embodiments, the transmit timing of the uplink positioning signal is a transmit timing of a first uplink time unit, or the transmit timing of the uplink positioning signal is a universal time coordinated (UTC) time corresponding to the transmit timing of the first uplink time unit.

The first uplink time unit includes at least one time unit corresponding to at least one of the N uplink positioning signal resources.

In some embodiments, the first uplink time unit includes at least one of: a time unit corresponding to a first uplink positioning signal resource of the N uplink positioning signal resources; a time unit corresponding to a last uplink positioning signal resource of the N uplink positioning signal resources; or a time unit of the N uplink positioning signal resources configured to determine the transmit timing of the uplink positioning signal.

In some embodiments, the time unit is at least one of a subframe, a slot, a frame, a symbol group, or a symbol.

In some embodiments, the first time information includes at least one of: a first downlink time unit; a first uplink time unit; a UTC time corresponding to the first downlink time unit; or a UTC time corresponding to the first uplink time unit; wherein the first downlink time unit is configured to determine a receive timing of the downlink positioning signal, and the first uplink time unit is configured to determine a transmit timing of the uplink positioning signal.

In some embodiments, the receiving module 1720 is further configured to receive at least one downlink positioning signal of M downlink positioning signals based on the M downlink positioning signal resources; and/or
the transmitting module 1740, is further configured to transmit at least one uplink positioning signal of N uplink positioning signals based on the N uplink positioning signal resources.

In some embodiments, the receiving module 1720 is further configured to receive the M downlink positioning signals based on the M downlink positioning signal resources.

In some embodiments, the transmitting module 1740 is further configured to transmit the N uplink positioning signals based on the N uplink positioning signal resources.

In some embodiments, the receiving module 1720 is further configured to receive the first configuration information transmitted by the network device; and/or receive the first configuration information transmitted by the LMF.

In some embodiments, the sending module 1740 is further configured to report the first measurement information to a network device based on the first configuration information; and/or report the first measurement information to an LMF based on the first configuration information.

In some embodiments, the downlink positioning signal resource includes a downlink PRS resources.

In some embodiments, the uplink positioning signal resource includes an uplink positioning SRS resource and/or an uplink MIMO SRS resource.

In some embodiments, the downlink positioning signal resource includes at least one of a downlink PRS resource, an SSB resource, a CSI-RS resource, a DMRS resource. Optionally, the DMRS resource includes a DMRS resource corresponding to a PDSCH and/or a DMRS resource corresponding to a PDCCH.

In some embodiments, the uplink positioning signal resource includes at least one of a positioning SRS resource, a MIMO SRS resource, a PRACH resource, a DMRS resource. Optionally, the DMRS resource includes a DMRS resource corresponding to a PUSCH and/or a DMRS resource corresponding to a PUCCH.

FIG. 18 illustrates a block diagram of a wireless communication apparatus for positioning according to some embodiments of the present disclosure. The device is implemented as a network device or a serving satellite by software, hardware or a combination of both. The apparatus includes: an acquiring module 1820; and a determining module 1840 and/or a transmitting module 1860.

The acquiring module 1820, configured to acquire first configuration information, wherein the first configuration information is used for determining M downlink positioning signal resources, and/or N uplink positioning signal resources, wherein M and N are positive integers. In some embodiments, the acquiring module 1820 includes a determining submodule configured to determine the first configuration information. In some embodiments, the acquisition module 1820 includes a receiving submodule configured to receive the first configuration information; and

The determining module 1840 is configured to determine second measurement information based on the first configuration information; and/or the transmitting module 1860 is configured to report second measurement information, wherein the second measurement information includes at least one of a second time difference and second time information.

In some embodiments, the M downlink positioning signal resources are downlink positioning signal resources in a first downlink positioning signal resource group of P downlink positioning signal resource groups, wherein P is a positive integer.

In some embodiments, the downlink positioning signal resources in the first downlink positioning signal resource group or downlink positioning signal resources in each of the P downlink positioning signal resource groups satisfy at least one of: a receive timing error in receiving a downlink positioning signal corresponding to a downlink positioning signal resource in a same downlink positioning signal resource group being within a first error range; or a transmit timing error in transmitting a downlink positioning signal corresponding to a downlink positioning signal resource in the same downlink positioning signal resource group being within a second error range.

In some embodiments, the N uplink positioning signal resources are uplink positioning signal resources in a first uplink positioning signal resource group of Q uplink positioning signal resource groups, wherein Q is a positive integer.

In some embodiments, the uplink positioning signal resources in the first uplink positioning signal resource group or uplink positioning signal resources in each of the Q uplink positioning signal resource groups satisfy at least one of: a transmit timing error in transmitting an uplink positioning signal corresponding to an uplink positioning signal resource in a same uplink positioning signal resource group being within a third error range; or a receive timing error in receiving an uplink positioning signal corresponding to an uplink positioning signal resource in the uplink positioning signal resource group being within a fourth error range.

In some embodiments, the M downlink positioning signal resources and the N uplink positioning signal resources are positioning signal resources in a first positioning signal resource group of R positioning signal resource groups, wherein R is a positive integer.

In some embodiments, the positioning signal resources in the first positioning signal resource group or positioning signal resources in each of the R positioning signal resource groups satisfy at least one of: a receive timing error in receiving a downlink positioning signal corresponding to a downlink positioning signal resource in a same positioning signal resource group being within a first error range; a transmit timing error in transmitting a downlink positioning signal corresponding to a downlink positioning signal resource in a same positioning signal resource group being within a second error range; a transmit timing error in transmitting an uplink positioning signal corresponding to an uplink positioning signal resource in a same positioning signal resource group being within a third error range; a receive timing error in receiving an uplink positioning signal corresponding to an uplink positioning signal resource in a same positioning signal resource group being within a fourth error range; an error of a sum of a receive timing error in receiving a downlink positioning signal corresponding to a downlink positioning signal resource in a same positioning signal resource group and a transmit timing error in transmitting an uplink positioning signal corresponding to an uplink positioning signal resource in a same positioning signal resource group being within a fifth error range; or an error of a sum of a transmit timing error in transmitting a downlink positioning signal corresponding to a downlink positioning signal resource in a same positioning signal resource group and a receive timing error in receiving an uplink positioning signal corresponding to an uplink positioning signal resource in a same positioning signal resource group being within a sixth error range.

In some embodiments, the second time difference is a difference between a receive timing of an uplink positioning signal and a transmit timing of a downlink positioning signal.

In some embodiments, the transmit timing of the downlink positioning signal is a transmit timing of a second downlink time unit, or the transmit timing of the downlink positioning signal is a universal time coordinated (UTC) time corresponding to the transmit timing of the second downlink time unit.

The second downlink time unit includes at least one time unit corresponding to at least one of the M downlink positioning signal resources.

In some embodiments, the second downlink time unit includes at least one of: a time unit corresponding to a first downlink positioning signal resource of the M downlink positioning signal resources; a time unit corresponding to a last downlink positioning signal resource of the M downlink positioning signal resources; or a time unit of the M downlink positioning signal resources configured to determine the transmit timing of the downlink positioning signal.

In some embodiments, the receive timing of the uplink positioning signal is a receive timing of a second uplink time unit, or the receive timing of the uplink positioning signal is a UTC time corresponding to the receive timing of the second uplink time unit.

The second uplink time unit includes at least one time unit corresponding to at least one of the N uplink positioning signal resources.

In some embodiments, the second uplink time unit includes at least one of: a time unit corresponding to a first uplink positioning signal resource of the N uplink positioning signal resources; a time unit corresponding to a last uplink positioning signal resource of the N uplink positioning signal resources; or a time unit of the N uplink positioning signal resources configured to determine a receive timing of the uplink positioning signal.

In some embodiments, the time unit is at least one of a subframe, a slot, a frame, a symbol group, or a symbol.

In some embodiments, the second time information includes at least one of: a second downlink time unit; a second uplink time unit; a UTC time corresponding to the second downlink time unit; or a UTC time corresponding to the second uplink time unit.

The second downlink time unit is configured to determine a transmit timing of the downlink positioning signal, and the second uplink time unit is configured to determine a receive timing of the uplink positioning signal.

In some embodiments, the second downlink timing unit is determined based on at least one of a downlink timing on a serving satellite, a downlink timing on a reference point, or a downlink timing on a network device; and the second uplink time unit is determined based on at least one of an uplink timing on the serving satellite, an uplink timing on the reference point, or an uplink timing on the network device.

In some embodiments, the device further includes a receiving module 1880.

The transmitting module 1860 is configured to transmit at least one downlink positioning signal of M downlink positioning signals based on the M downlink positioning signal resources; and/or the receiving module 1880 is configured to receive at least one uplink positioning signal of N uplink positioning signals based on the N uplink positioning signal resources.

In some embodiments, the transmitting module 1860 is configured to the M downlink positioning signals based on the M downlink positioning signal resources; and the receiving module 1880 is configured to receive the N uplink positioning signals based on the N uplink positioning signal resources.

In some embodiments, the acquiring module 1820 includes: a determining submodule, configured to determine the first configuration information; and/or a receiving submodule, configured to receive the first configuration information transmitted by the LMF.

In some embodiments, the transmitting module 1860 is configured to reporting the second measurement information to the LMF based on the first configuration information.

In some embodiments, the downlink positioning signal resource includes a downlink PRS resource; and/or the uplink positioning signal resource includes an uplink positioning SRS resource and/or uplink MIMO SRS resource.

In some embodiments, the downlink positioning signal resource includes at least one of a downlink PRS resource, an SSB resource, a CSI-RS resource, or a DMRS resource. Optionally, the DMRS resource includes a DMRS resource corresponding to a PDSCH and/or a DMRS resource corresponding to a PDCCH.

In some embodiments, the uplink positioning signal resource includes at least one of a positioning SRS resource, a MIMO SRS resource, a PRACH resource, or a DMRS resource. Optionally, the DMRS resource includes a DMRS resource corresponding to a PUSCH and/or a DMRS resource corresponding to a PUCCH.

It is to be noted that the apparatus provided by the above embodiments is only illustrated by example with the division of each of the above functional modules, and in actual application, the above functions may be assigned to be accomplished by different functional modules based on the demand, that is, the internal structure of the apparatus may be divided into different functional modules to achieve all or part of the above functions. In addition, the apparatus according to the above embodiments belongs to the same concept as the method embodiment, and the implementation process of the apparatus is detailed in the method embodiments, which is not repeated herein.

FIG. 19 illustrates a schematic structural diagram of a communication device (terminal device or network device or serving satellite) according to some embodiments of the present disclosure. The communication device 190 includes: a processor 1901, a receiver 1902, a transmitter 1903, a memory 1904, and a bus 1905.

The processor 1901 includes one or more processing cores, and the processor 1901 performs various functional applications and information processing by running software programs and modules.

The receiver 1902 and the transmitter 1903 are implemented as a communication component, which may be a communication chip.

The memory 1904 is connected to the processor 1901 via a bus 1905.

The memory 1904 is configured to store at least one instruction, and the processor 1901 is configured to execute the at least one instruction to perform the various processes in the above method embodiments.

In addition, the memory 1904 is implemented by any type of volatile or non-volatile storage device or a combination thereof. The volatile or non-volatile storage device includes, but is not limited to: a disk or optical disk, an electrically erasable programmable read-only memory (EEPROM), an erasable programmable erasable programmable read-only memory (EPROM), a static random-access memory (SRAM), a read-only memory (ROM), a magnetic memory, a flash memory, a programmable read-only memory (ROM), a magnetic memory, a flash memory, a programmable read-only memory (PROM).

In the case the communication device is implemented as a terminal device, the processor and the transceiver in the communication device according to the embodiments of the present disclosure are implemented together as a communication chip, or the transceiver forms a communication chip alone. The transmitter in the transceiver performs a transmission process performed by the terminal device in any of the above methods, the receiver in the transceiver performs a reception process performed by the terminal device in any of the above methods, and the processor performs processes other than the transmission and reception processes, which is not described herein.

In the case that the communication device is implemented as an access network device, the processor and the transceiver in the communication device involved in the embodiments of the present disclosure are implemented together as a communication chip, or the transceiver forms a communication chip alone. The transmitter in the transceiver performs a transmission process performed by the access network device in any of the above methods, the receiver in the transceiver performs a reception process performed by the access network device in any of the above methods, and the processor performs processes other than the transmission and reception processes, which is not described herein.

In the case that the communication device is implemented as a core network device (e.g., LMF), the processor and the transceiver in the communication device involved in the embodiments of the present disclosure are implemented together as a communication chip, or the transceiver forms a communication chip alone. The transmitter in the transceiver performs the transmission process performed by the LMF in any of the above methods, the receiver in the transceiver performs the reception process performed by the LMF in any of the above methods, and the processor performs processes other than the transmission and reception processes, which is not described herein.

In the case that the communication device is implemented as a serving satellite device, the processor and the transceiver in the communication device according to the embodiments of the present disclosure are implemented together as a communication chip, or the transceiver forms a communication chip alone. The transmitter in the transceiver performs the transmission process performed by the serving satellite device in any of the above methods, the receiver in the transceiver performs the reception process performed by the serving satellite device in any of the above methods, and the processor performs processes other than the transmission and reception processes, which is not described herein.

In some embodiments, a computer-readable storage medium is further provided. The computer-readable storage medium stores at least one instruction, at least one segment of a program, a code set, or a set of instructions. The at least one instruction, the at least one segment of the program, or the set of codes or set of instructions, when loaded and executed by the processor, causes the processor to perform the wireless communication method for positioning according to each of the above method embodiments.

In some embodiments, a chip is further provided. The chip includes at least one programmable logic circuit and/or at least one program instruction, wherein a communication device equipped with the chip, when running, is caused to perform the wireless communication method for positioning according to each of the above method embodiments

In some embodiments, a computer program product or computer program is further provided. The computer program product or computer program includes at least one instruction, at least one segment of a program, a code set, or a set of instructions, wherein the at least one instruction, at least one segment of a program, a code set, or a set of instructions, when loaded and run by a processor of a communication device, causes the communication device to perform the above wireless communication method for positioning.

It should be appreciated by those skilled in the art that in one or more of the above embodiments, the functions described in the embodiments of the present disclosure may be implemented by hardware, software, firmware, or any combination thereof. When implemented by software, the functions are stored in a computer-readable medium or transmitted as one or more instructions or code on the computer-readable medium. The computer-readable medium includes computer storage medium and communication medium, wherein the communication medium includes any medium that facilitates the transmission of a computer program from one location to another. The storage medium is any available medium to which a general purpose or specialized computer has access.

Described above are only exemplary embodiments of the present disclosure and are not intended to limit the present disclosure, and any modifications, equivalent substitutions, improvements, and the like made within the spirit and principles of the present disclosure shall be included in the scope of protection of the present disclosure.

1. A wireless communication method for positioning, applicable to a terminal device, the method comprising:
receiving first configuration information, wherein the first configuration information is used for determining M downlink positioning signal resources and/or N uplink positioning signal resources, wherein M and N are positive integers; and
reporting first measurement information based on the first configuration information, wherein the first measurement information comprises at least one of a first time difference or first time information.

2. The method according to claim 1, wherein
the first time difference is a difference between a receive timing of a downlink positioning signal and a transmit timing of an uplink positioning signal.

3. The method according to claim 2, wherein
the receive timing of the downlink positioning signal is a receive timing of a first downlink time unit, or the receive timing of the downlink positioning signal is a universal time coordinated (UTC) time corresponding to the receive timing of the first downlink time unit;
wherein the first downlink time unit comprises at least one time unit corresponding to at least one of the M downlink positioning signal resources; and
the first downlink time unit comprises at least one of:
a time unit corresponding to a first downlink positioning signal resource of the M downlink positioning signal resources;
a time unit corresponding to a last downlink positioning signal resource of the M downlink positioning signal resources; or
a time unit of the M downlink positioning signal resources for determining the receive timing of the downlink positioning signal.

4. The method according to claim 2, wherein
the transmit timing of the uplink positioning signal is a transmit timing of a first uplink time unit, or the transmit timing of the uplink positioning signal is a universal time coordinated (UTC) time corresponding to the transmit timing of the first uplink time unit;
wherein the first uplink time unit comprises at least one time unit corresponding to at least one of the N uplink positioning signal resources.

5. The method according to claim 4, wherein the first uplink time unit comprises at least one of:
a time unit corresponding to a first uplink positioning signal resource of the N uplink positioning signal resources;
a time unit corresponding to a last uplink positioning signal resource of the N uplink positioning signal resources; or
a time unit of the N uplink positioning signal resources for determining the transmit timing of the uplink positioning signal.

6. The method according to claim 3, wherein the time unit is at least one of a subframe, a slot, a frame, a symbol group, or a symbol.

7. The method according to claim 1, wherein a unit of the first time difference is a subframe.

8. A wireless communication method for positioning, applicable to a network device or a serving satellite device, the method comprising:
acquiring first configuration information, wherein the first configuration information is used for determining M downlink positioning signal resources, and/or N uplink positioning signal resources, wherein M and N are positive integers; and
determining or reporting second measurement information based on the first configuration information, wherein the second measurement information comprises at least one of a second time difference or second time information.

9. The method according to claim 8, wherein
the second time difference is a difference between a receive timing of an uplink positioning signal and a transmit timing of a downlink positioning signal.

10. The method according to claim 9, wherein
the transmit timing of the downlink positioning signal is a transmit timing of a second downlink time unit, or the transmit timing of the downlink positioning signal is a universal time coordinated (UTC) time corresponding to the transmit timing of the second downlink time unit;
wherein the second downlink time unit comprises at least one time unit corresponding to at least one of the M downlink positioning signal resources.

11. The method according to claim 9, wherein
the receive timing of the uplink positioning signal is a receive timing of a second uplink time unit, or the receive timing of the uplink positioning signal is a universal time coordinated (UTC) time corresponding to the receive timing of the second uplink time unit;
wherein the second uplink time unit comprises at least one time unit corresponding to at least one of the N uplink positioning signal resources.

12. The method according to claim 10, wherein
the second downlink timing unit is determined based on at least one of a downlink timing on a serving satellite, a downlink timing on a reference point, or a downlink timing on a network device; and
the second uplink time unit is determined based on at least one of an uplink timing on the serving satellite, an uplink timing on the reference point, an uplink timing on the network device.

13. A terminal device, comprising:
a processor;
a transceiver coupled to the processor; and
a memory configured to store one or more executable instructions;
wherein the processor, when loading and executing the one or more executable instructions, is caused to perform a wireless communication method for positioning; and
the method comprises:
receiving first configuration information, wherein the first configuration information is used for determining M downlink positioning signal resources and/or N uplink positioning signal resources, wherein M and N are positive integers; and
reporting first measurement information based on the first configuration information, wherein the first measurement information comprises at least one of a first time difference or first time information.

14. The terminal device according to claim 13, wherein the first time difference is a difference between a receive timing of a downlink positioning signal and a transmit timing of an uplink positioning signal.

15. The terminal device according to claim 14, wherein
the receive timing of the downlink positioning signal is a receive timing of a first downlink time unit, or the receive timing of the downlink positioning signal is a universal time coordinated (UTC) time corresponding to the receive timing of the first downlink time unit;
wherein the first downlink time unit comprises at least one time unit corresponding to at least one of the M downlink positioning signal resources; and
the first downlink time unit comprises at least one of:
a time unit corresponding to a first downlink positioning signal resource of the M downlink positioning signal resources;
a time unit corresponding to a last downlink positioning signal resource of the M downlink positioning signal resources; or
a time unit of the M downlink positioning signal resources for determining the receive timing of the downlink positioning signal.

16. The terminal device according to claim 14, wherein
the transmit timing of the uplink positioning signal is a transmit timing of a first uplink time unit, or the transmit timing of the uplink positioning signal is a universal time coordinated (UTC) time corresponding to the transmit timing of the first uplink time unit;
wherein the first uplink time unit comprises at least one time unit corresponding to at least one of the N uplink positioning signal resources.

17. The terminal device according to claim 16, wherein the first uplink time unit comprises at least one of:
a time unit corresponding to a first uplink positioning signal resource of the N uplink positioning signal resources;
a time unit corresponding to a last uplink positioning signal resource of the N uplink positioning signal resources; or
a time unit of the N uplink positioning signal resources for determining the transmit timing of the uplink positioning signal.

18. The terminal device according to claim 15, wherein the time unit is at least one of a subframe, a slot, a frame, a symbol group, or a symbol.

19. A network device or serving satellite, wherein the network device or serving satellite comprises:
a processor;
a transceiver coupled to the processor; and
a memory configured to store one or more executable instructions;
wherein the processor, when loading and executing the one or more executable instructions, is caused to perform the method as defined in claim 8.

20. A chip, comprising at least one programmable logic circuit and/or at least one program instruction, wherein a communication device equipped with the chip, when running, is caused to perform the method as defined in claim 1.
